(19) United States
(12) Patent Application Publication
(10) Pub. No.: US 2023/0195106 A1
(43) Pub. Date: Jun. 22, 2023

(54) MOBILE TERMINAL SYSTEM FOR AUTONOMOUS VEHICLES

(71) Applicant: TuSimple, Inc., San Diego, CA (US)

(72) Inventors: Erik Andrew Siegler, San Diego, CA (US); Joyce Tam, Pleasanton, CA (US)

(21) Appl. No.: 18/068,092

(22) Filed: Dec. 19, 2022

Related U.S. Application Data
(60) Provisional application No. 63/265,728, filed on Dec. 20, 2021.
(60) Provisional application No. 63/265,734, filed on Dec. 20, 2021.

(51) Int. Cl. G05D 1/00; G05D 1/02

(52) U.S. Cl. CPC G05D 1/0027; G05D 1/0214; G05D 1/0278; G05D 2201/0213

(57) ABSTRACT

A mobile terminal system includes equipment used to establish a terminal site with at least one landing pad sized and shaped to accommodate an autonomous vehicle of a fleet. A control subsystem determines that an autonomous vehicle of the fleet is in-bound to the established terminal site. After determining the in-bound autonomous vehicle, landing instructions are determined that indicate a landing pad in which the in-bound autonomous vehicle is to stop and a route that the in-bound autonomous vehicle is to travel along to reach the landing pad. The landing instructions are provided to the in-bound autonomous vehicle. The landing instructions cause the in-bound autonomous vehicle to travel along the route to the landing pad.

### PRIORITY

This application claims priority to U.S. Provisional Pat. Application No. 63/265,728 filed on Dec. 20, 2021, and titled “MOBILE TERMINAL SYSTEM FOR AUTONOMOUS VEHICLES,” and U.S. Provisional Pat. Application No. 63/265,734 filed on Dec. 20, 2021, and titled “SYSTEM FOR RAPID DEPLOYMENT OF TERMINALS FOR AUTONMOUS VEHICLES,” which are incorporated herein by reference.

### TECHNICAL FIELD

The present disclosure relates generally to autonomous vehicles. More particularly, in certain embodiments, the present disclosure is related to a mobile terminal system for autonomous vehicles.

### BACKGROUND

One aim of autonomous vehicle technology is to provide vehicles that can safely navigate towards a destination with limited or no driver assistance. In some cases, an autonomous vehicle may allow a driver to operate the autonomous vehicle as a conventional vehicle by controlling the steering, throttle, clutch, gear shifter, and/or other vehicle control devices. In other cases, a driver may engage the autonomous vehicle navigation technology to allow the vehicle to drive autonomously. There exists a need to operate autonomous vehicles more safely and reliably.

### SUMMARY

This disclosure recognizes various problems and previously unmet needs related to autonomous vehicle navigation and driving, including the lack of tools for efficiently establishing and operating resources to launch autonomous vehicles reliably from a location and land autonomous vehicles at the location. For instance, if an autonomous vehicle is leaving a given location, a driver may currently be required to steer the autonomous vehicle along an initial portion of a route (e.g., until the autonomous vehicle is on an appropriate road to begin driving autonomously). As another example, it is not possible to efficiently and reliably land an autonomous vehicle at a given location when the autonomous vehicle reaches its destination. In these instances, a driver typically takes control of the autonomous vehicle to steer the vehicle to an appropriate stopping point.

Certain embodiments of this disclosure solve these and other problems, including those described above, by facilitating the efficient, safe, and reliable setup and operation of terminal sites for an autonomous vehicle fleet using a mobile terminal system. The mobile terminal system includes equipment for setting up and operating a terminal site where autonomous vehicles can land (e.g., to drop of transported items, people, etc.) and launch (e.g., to begin traveling to transport items, people, etc.). The terminal site setup by the mobile terminal system includes landing pads that can hold or accommodate incoming autonomous vehicles and/or launchpads that can hold or accommodate outgoing autonomous vehicles that are exiting the terminal site. A control subsystem of the mobile terminal system aids in directing launching and landing operations of the autonomous vehicles. The disclosed mobile terminal system provides several technical advantages by providing, for example, 1) improved availability of supplies, such as position delineators, sensors, and the like, for quickly and efficiently setting up a terminal site with landing pad(s) and/or launchpad(s); 2) improved landing of autonomous vehicles at specially designated landing pads that facilitate the efficient and reliable direction of an autonomous vehicle to an appropriate stopping location that is free of obstructions; 3) improved launching of autonomous vehicles from specially designated launchpads that facilitate the efficient and reliable starting or “launching” of an autonomous vehicle to begin moving along a route; 4) increased ability to efficiently generate route data for autonomous vehicles to follow to reach a terminal site newly established by the mobile terminal system; and 5) increased ability to rapidly and efficiently establish new terminal sites or provide supplemental control resources to existing terminal sites when needed. As such, this disclosure may improve the function of computer systems used to support operations of a fleet of autonomous vehicles and improve autonomous vehicle navigation during at least a portion of a journey taken by the autonomous vehicles.

In some embodiments, the mobile terminal system described in this disclosure may be integrated into a practical application of a vehicle that includes equipment for rapidly deploying, or setting up, a new terminal site on an on-demand basis when the need arises. The equipment allows a terminal site to be rapidly deployed on demand to support a fleet of autonomous vehicles. This disclosure is also integrated into the practical application of a control subsystem that more efficiently and reliably directs movement of autonomous vehicles into and out of a rapidly deployed terminal site than was previously possible. The mobile terminal system facilitates the efficient, safe, and reliable routing and landing (e.g., parking or stopping) of an autonomous vehicle at an appropriate landing pad of the rapidly deployed terminal site that is free of obstructions. The mobile terminal system also or alternatively facilitates the reliable and efficient launching and routing of autonomous vehicles out of the terminal site.

In some embodiments, the control subsystem is in communication with sensors positioned in, near, and/or around the landing pad and/or launchpad. Information from these sensors is used (e.g., alone or in combination with information from autonomous vehicle sensors) to direct movement of the autonomous vehicles into appropriate landing pads and/or out of launchpads efficiently and reliably. For instance, when an autonomous vehicle is incoming to the terminal site, the control subsystem of the mobile terminal system may receive information from the sensors and use this sensor information to identify a landing pad that is available to receive an incoming autonomous vehicle and/or a route leading to the identified the landing pad. If the route leading to the identified landing pad becomes obstructed, the control subsystem may identify a different landing pad that is free of obstructions and/or a different route to the landing pad. Launch instructions are provide to the incoming autonomous vehicle that cause the autonomous vehicle to follow this route to the landing pad. The mobile terminal system may reduce or eliminate practical and technical barriers or bottlenecks to receiving large numbers of autonomous vehicles at a rapidly deployed terminal site, such as a location to which a freight is transported, with little or no human intervention.

As another example, when an autonomous vehicle needs to exit a launchpad, information from sensors in, on, or near the launchpad may be used (e.g., alone and/or in combination with autonomous vehicle sensor data) to determine whether a space around the autonomous vehicle and launchpad is sufficiently clear to begin movement. Launch instructions provided from the mobile terminal system facilitate improved automatic launching of an autonomous vehicle to begin moving along a route without requiring action by a driver. The launch instructions may indicate an efficient path for exiting the terminal site. This approach may reduce or eliminate practical and technical barriers to launching autonomous vehicles from rapidly deployed terminal sites, such as those commonly encountered, for example, for the movement of freight and/or people.

Certain embodiments of this disclosure may include some, all, or none of these advantages. These advantages and other features will be more clearly understood from the following detailed description taken in conjunction with the accompanying drawings and claims.

In an embodiment, a mobile terminal system includes a vehicle with (e.g., capable of storing) position delineators configured when deployed to establish a terminal site within a physical space. The established terminal site includes at least one landing pad sized and shaped to accommodate an autonomous vehicle of the fleet. The mobile terminal system includes a control subsystem with a hardware processor that determines that an autonomous vehicle of the fleet is in-bound to the established terminal site. After determining that the in-bound autonomous vehicle of the fleet is in-bound to the established terminal site, landing instructions are determined that indicate a landing pad in which the in-bound autonomous vehicle is to stop and a route that the in-bound autonomous vehicle is to travel along to reach the landing pad. The landing instructions are provided to the in-bound autonomous vehicle. The landing instructions cause the in-bound autonomous vehicle to travel along the route to the landing pad (e.g., after being received by an in-vehicle control system of the in-bound autonomous vehicle).

In another embodiment, a mobile terminal system includes a vehicle with (e.g., capable of storing) position delineators configured when deployed to establish a terminal site within a physical space. The established terminal site includes at least one launchpad sized and shaped to accommodate an autonomous vehicle of the fleet. The mobile terminal system includes a control subsystem with a hardware processor that determines that an autonomous vehicle of the fleet is requesting to depart from the launchpad. After determining that the autonomous vehicle of the fleet is requesting to depart from the launchpad, launch instructions are determined that indicate whether the autonomous vehicle can exit the launchpad and a route along which the autonomous vehicle is to travel after exiting the launchpad. The launch instructions are provided to the autonomous vehicle. The launch instructions cause the autonomous vehicle to exit the launchpad and move along the route (e.g., after being received by an in-vehicle control system of the autonomous vehicle).

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an example mobile terminal system;

FIG. 2 is a diagram illustrating example routes that can be traveled by autonomous vehicles between terminal sites established by the mobile terminal system of FIG. 1;

FIG. 3 is a diagram illustrating an example terminal site of FIG. 2 in greater detail;

FIG. 4 is a flowchart of an example method of operating the mobile terminal system of FIG. 1;

FIG. 5 is a diagram of an example autonomous vehicle configured to implement autonomous driving operations;

FIG. 6 is an example system for providing autonomous driving operations used by the autonomous vehicle of FIG. 5;

FIG. 7 is diagram of an in-vehicle control computer included in an autonomous vehicle;

FIG. 8 is a diagram illustrating operation of an example launchpad;

FIG. 9 is a flowchart of an example method of operating a launchpad;

FIG. 10 is a diagram illustrating operation of an example landing pad;

FIG. 11 is a flowchart of an example method of operating a landing pad;

FIG. 12A is a diagram illustrating an example mobile relaunching operation;

FIG. 12B is a diagram illustrating an example mobile relaunching device of FIG. 12A; and

FIG. 13 is a flowchart of an example mobile relaunching method.

### DETAILED DESCRIPTION

Typically, terminals are areas where the autonomous driving system of each autonomous vehicle can be engaged and disengaged safely. Terminals also provide a space in which activities can be performed such as inspecting mechanical components of autonomous vehicles, cleaning autonomous vehicle sensors, calibrating autonomous vehicle sensors, repairing autonomous vehicle, adding fluids to autonomous vehicles, refueling autonomous vehicles, performing trailer operations (e.g., loading, inspection, weighing, sealing), offloading data storage from autonomous vehicles (e.g., by pulling physical memory from autonomous vehicles and/or transferring via wireless communication), and attaching/detaching trailers to autonomous vehicles.

This disclosure recognizes the previously unrecognized and unmet need for tools to rapidly, efficiently, and reliably establish new terminals (also referred to herein as terminal sites) to support movements of a fleet of autonomous vehicles. Such rapidly deployed terminal sites, which are possible using the mobile terminal system of this disclosure, may satisfy a short-term need for a route, such as when a proof-of-concept route is being tested for an autonomous vehicle fleet or when a temporary route is needed to circumvent an area (e.g., in case a previous route is unavailable or no longer adequate). As an example, a mobile terminal site may help support an alternative route in cases when a natural disaster or road construction makes a previous route no longer sustainable. As another example, a mobile terminal site may satisfy a short-term increase in shipping volume needs, such as during certain times of the year when shipping volume increases or at the onset of added shipping volume in a given location. In some of these and other cases, a terminal site may need to be established quickly and used in a matter of hours or days as opposed to the weeks which may be required to establish a conventional terminal. The mobile terminal system of this disclosure can be used in these circumstances to help support the movements of autonomous vehicle fleets. The mobile terminal system of this disclosure can establish a functional terminal site without requiring any fixed structures

This disclosure provides the practical application of a mobile terminal system that solves the above-described and other problems. In addition to providing resources for rapidly deploying new terminal sites and/or augmenting existing sites, the mobile terminal system is configured to help direct autonomous vehicle movements to, from, and within the terminal site. This disclosure allows autonomous vehicles to travel more efficiently and reliably than was previously possible by facilitating autonomous vehicles to travel as much as possible without intervention by a human operator. The mobile terminal system also includes a control subsystem that not only helps direct landing and launching movements of autonomous vehicles but also improves execution of tasks for unloading, loading, inspecting, and maintaining autonomous vehicles.

### Mobile Terminal System

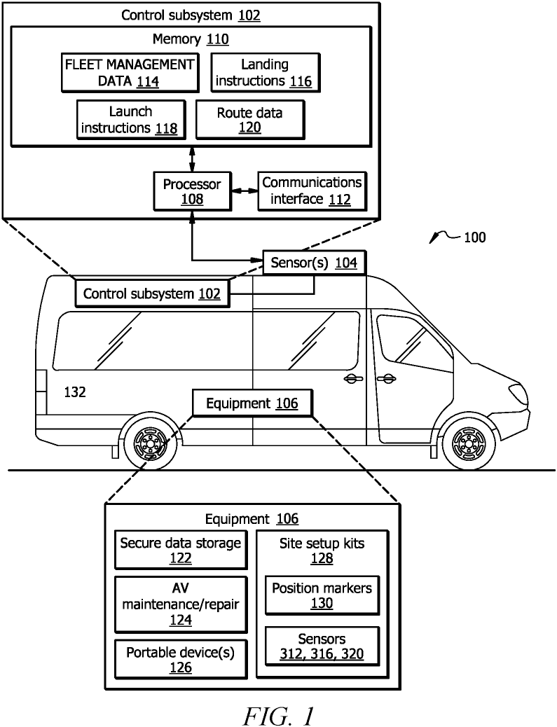

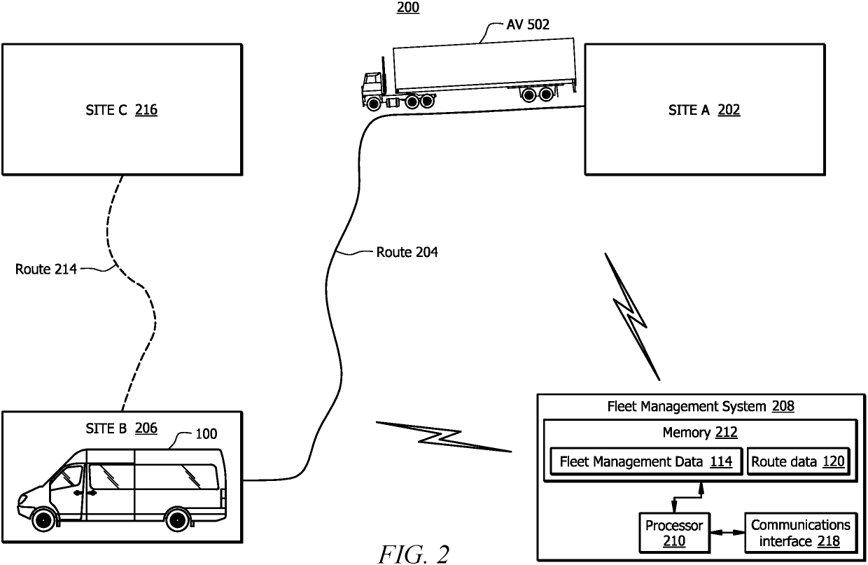

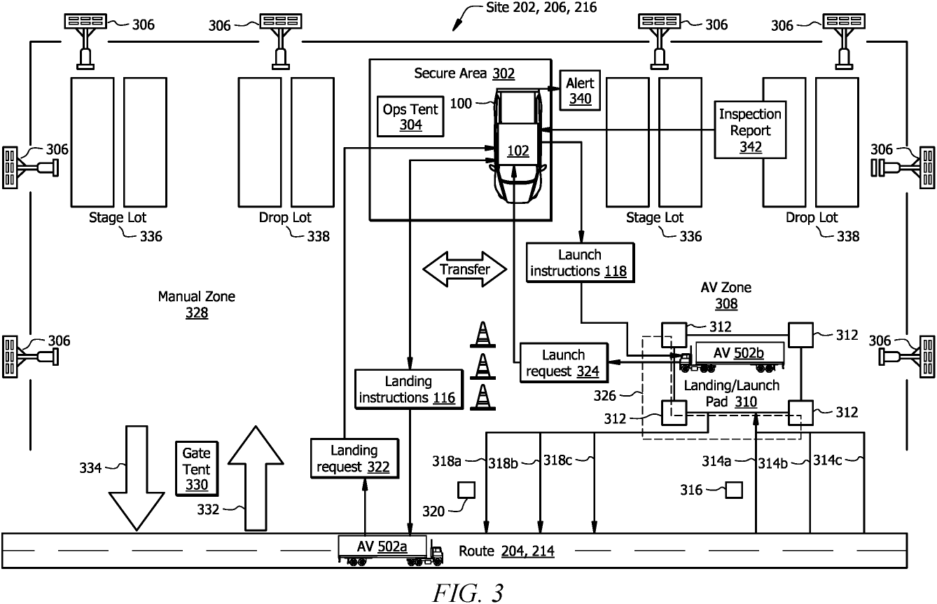

FIG. 1 shows an example mobile terminal system 100. The mobile terminal system 100 includes a vehicle 132, a control subsystem 102, one or more sensors 104, and equipment 106 for setting up new terminal sites (e.g., sites 202, 206, 216 of FIGS. 2 and 3). The vehicle 132 can generally be any type of vehicle capable of transporting control subsystem 102, sensors 104, and equipment 106. For example, the vehicle 132 may be a van as illustrated in the example of FIG. 1 or any other appropriately sized vehicle. In some embodiments, the vehicle 132 is a larger vehicle such as a camper truck or bus and may include, for example, bathroom facilities.

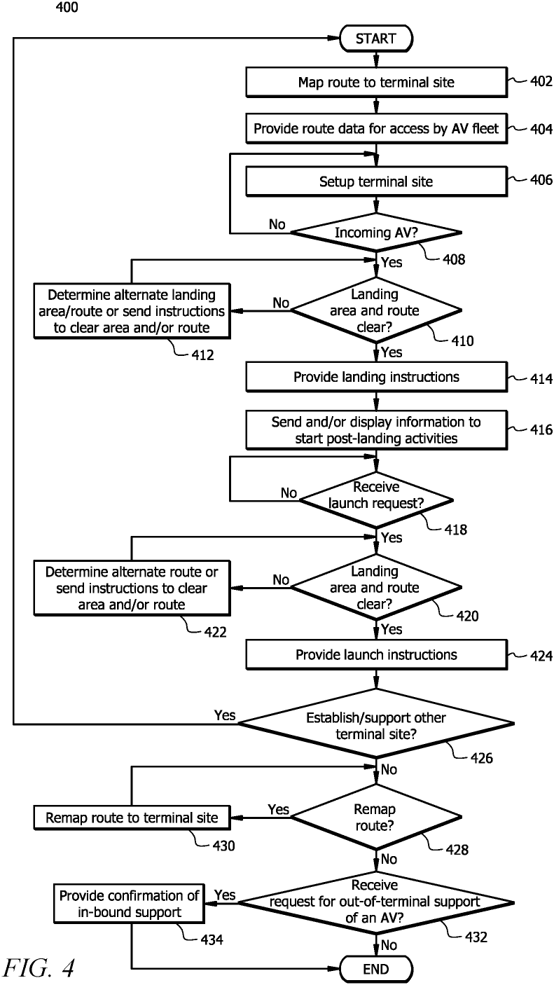

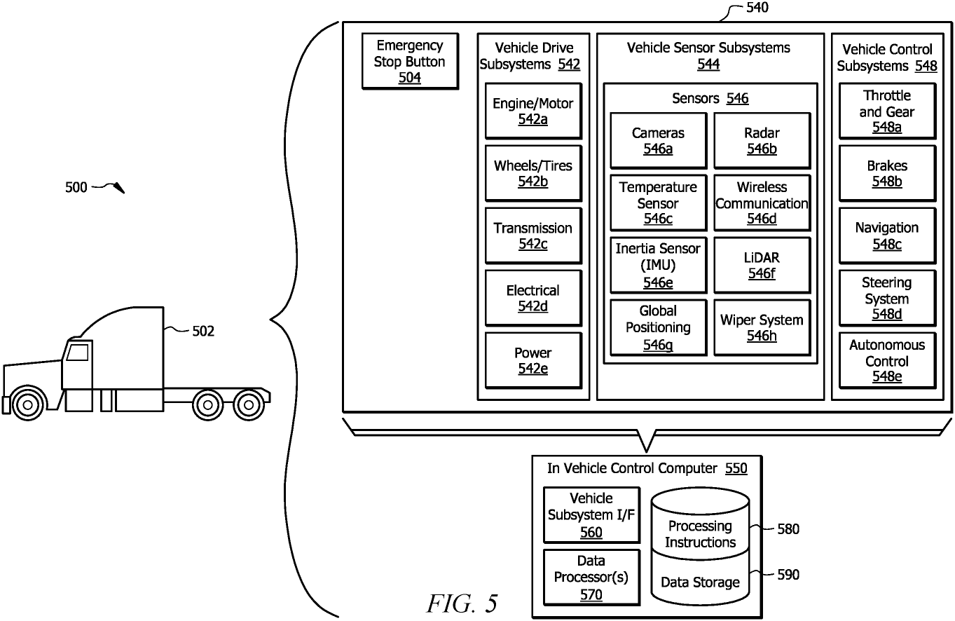

The control subsystem 102 is a device that coordinates operations of the mobile terminal system 100 and provides information to the autonomous vehicle fleet to improve performance of a fleet of autonomous vehicles (see autonomous vehicle 502 of FIG. 5, described below). For example, landing instructions 116 and launch instructions 118 may be determined by the control system 102 and provided to incoming and outgoing autonomous vehicles to better direct autonomous vehicle movements during landing at a terminal site and exiting a terminal site, as described in greater detail below with respect to FIGS. 3 and 4. Fleet management data 114 may be used to determine when and where there is a need to establish a terminal site, and route data 120 is collected by the mobile terminal system 100 and used by the fleet of autonomous vehicles to navigate to terminal sites. Route data 120 may also capture environmental changes around a terminal site and/or to establish one or more new lanes in or around a terminal site. The control subsystem 102 includes a processor 108, memory 110, and communications interface 112. The processor 108 includes one or more processors. The processor 108 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 108 may be a programmable logic device, a microcontroller, a microprocessor, or any suitable combination of the preceding. The processor 108 is communicatively coupled to and in signal communication with the memory 110 and communications interface 112, and sensor(s) 104 (described further below). The one or more processors are configured to process data and may be implemented in hardware and/or software. For example, the processor 108 may be 8-bit, 16-bit, 32-bit, 64-bit or of any other suitable architecture. The processor 108 may include an arithmetic logic unit (ALU) for performing arithmetic and logic operations, processor registers that supply operands to the ALU and store the results of ALU operations, and a control unit that fetches instructions from memory 110 and executes them by directing the coordinated operations of the ALU, registers and other components.

The memory 110 is operable to store fleet management data 114, landing instructions 116, launch instructions 118, route data 120 (e.g., including data for new routes or updated data for existing routes), and/or any other data, instructions, logic, rules, or code operable to execute functions of the mobile terminal system 100. The fleet management data 114 may include current positions and planned destination of autonomous vehicles in a fleet. The fleet management data 114 may include planned routes the autonomous vehicles will travel along to reach destinations. The fleet management data 114 may be used to determine when and where a new terminal site should be deployed, as described further below with respect to FIG. 2. The landing instructions 116 indicate movements that an incoming autonomous vehicle of the fleet can perform to reach a landing pad within a terminal site (see FIGS. 3 and 4). For example, landing instructions 116, when executed by an autonomous vehicle, may direct at least a portion of operations of the autonomous vehicle to reach a landing pad in a terminal site. The launch instructions 118 indicate movements that an outgoing autonomous vehicle of the fleet that is on a launchpad in a terminal site can perform to exit the launchpad. For example, launch instructions 118, when executed by an autonomous vehicle, may direct at least a portion of operations of the outgoing autonomous vehicle to leave the launchpad and reach a transportation route (e.g., a road). The route data 120 may indicate a route (e.g., a route 204, 214 of FIG. 2) for autonomous vehicles of the fleet to travel along to reach a terminal site. Route data 120 may include data collected by sensors 104, such as road condition information, obstructions to travel, traffic, etc. The memory 110 includes one or more disks, tape drives, or solid-state drives, and may be used as an over-flow data storage device, to store programs when such programs are selected for execution, and to store instructions and data that are read during program execution. The memory 110 may be volatile or non-volatile and may comprise read-only memory (ROM), random-access memory (RAM), ternary content-addressable memory (TCAM), dynamic random-access memory (DRAM), and static random-access memory (SRAM).

The communications interface 112 is configured to communicate data between the control subsystem 102 and other devices, systems, or domain(s), such as autonomous vehicles 502 of the fleet and a fleet management system (see fleet management system 208 of FIG. 2). The communications interface 112 is an electronic circuit that is configured to enable communications between devices. For example, the communications interface 112 may include one or more serial ports (e.g., USB ports or the like) and/or parallel ports (e.g., any type of multi-pin port) for facilitating communication with local devices, such as sensors 104. As a further example, the communications interface 112 may be a network interface that includes a cellular communication transceiver, a WIFI interface, a local area network (LAN) interface, a wide area network (WAN) interface, a modem, a switch, and/or a router. The processor 108 is configured to send and receive data using the communications interface 112. The communications interface 112 may be configured to use any suitable type of communication protocol. The communications interface 112 communicates fleet management data 114, landing instructions 116, launch instructions 118, and route data 120.

The sensors 104 may include any number of sensors configured to sense information about a location, an environment, or other conditions around the vehicle 132 of the mobile terminal system 100. The sensors 104 may include one or more of the sensors 546 illustrated in FIG. 5 and described further below. The sensors 104 may include one or more cameras or image capture devices, a RADAR unit, one or more temperature sensors, an inertial measurement unit (IMU), a laser range finder/LIDAR unit, and/or a Global Positioning System (GPS) transceiver. The IMUs of sensors 104 may include any combination of sensors (e.g., accelerometers and gyroscopes) configured to sense position and orientation changes of the vehicle 132 (e.g., along a route 204, 214 of FIG. 2). The GPS transceiver of sensors 104 may be any sensor configured to estimate a geographic location of the vehicle 132 (e.g., traveling along a route 204, 214 of FIG. 2). The GPS transceiver may include a receiver/transmitter operable to provide information regarding the position of the vehicle 132 with respect to the Earth. The RADAR unit of sensors 104 may be configured to use radio signals to sense objects within the local environment of the vehicle 132 (e.g., along a route 204, 214 of FIG. 2). The laser range finder or LIDAR unit of sensors 104 may be any sensor(s) configured to sense objects in the environment of the vehicle 132 using lasers (e.g., along a route 204, 214 of FIG. 2). The cameras of sensors 104 may include one or more devices configured to capture a plurality of images (e.g., still images or video) of the environment of the vehicle 132 (e.g., along a route 204, 214 of FIG. 2).

Information collected and/or generated by the sensors 104 may be included in the route data 120. For example, the route data 120 may provide coordinates (e.g., from a GPS transceiver of sensors 104) to travel to reach the established terminal site 206. The route data 120 may include information about the route detected by sensors 104, such as closed lanes, obstructions on or near route, traffic, and the like. This more detailed route information may further improve operation of the autonomous vehicles of the fleet because the autonomous vehicles may be operated more efficiently and reliably when more is known about a planned route than geographic coordinates alone.

The equipment 106 includes any materials, supplies, and resources that can be used to deploy a new (e.g., short-term or temporary) terminal site (see FIG. 3 and the corresponding description below for a more detailed description of an example terminal site). Equipment 106 of the mobile terminal system 100 can be deployed to any location that is suitable (e.g., sufficiently flat, sufficiently large, located in an area along a mapped route 204, 214 of FIG. 2) to quickly add capacity or capability to the fleet of autonomous vehicles. Equipment 106 may include secure data storage 122, autonomous vehicle maintenance/repair kits 124, one or more portable devices 126, and site setup kits 128. The equipment 106 may be packaged for efficient transport and deployment on an as-needed or temporary manner (e.g., equipment 106 may be foldable, modular, and/or made with a less permanent construction). The equipment 106 may include less than the full set of equipment used to establish a full conventional terminal site. For example, the secure data storage 122 may have a decreased capacity compared to that a full conventional terminal site and the autonomous vehicle maintenance/repair kits 124 may have fewer tools and replacement parts than are included in a permanent conventional terminal site. At least certain of the equipment 106, such as cameras, lights, and traffic barriers, may improve safety and security within a terminal site. Other equipment 106, such as portable device(s) 126 improve efficiency of autonomous vehicle operations in terminal sites by allowing alerts (see alerts 340 of FIG. 3) to be sent to appropriate technicians or others responsible for supporting autonomous vehicle landing and launching activities, as described further below.

The equipment 106 may facilitate both setting up a physical space to operate as a new (e.g., short-term terminal site - see FIG. 3) and performing fleet-support actions in the terminal site, such as inspecting mechanical components of autonomous vehicles, cleaning and/or calibrating autonomous vehicle sensors (see sensors 546 of FIG. 5), repairing autonomous vehicle, adding fluids to autonomous vehicles, refueling autonomous vehicles, performing trailer operations (e.g., loading, inspection, weighing, sealing of trailers), offloading data storage from autonomous vehicles (e.g., by pulling physical memory from autonomous vehicles and/or transferring via wireless communication), and attaching/detaching trailers to autonomous vehicles.

Secure data storage 122 may be any secure data storage (e.g., the same as or similar to memory 110, described above) to offload data from autonomous vehicles in a terminal site. For example, when an autonomous vehicle lands at a terminal site, data about recent trips performed by the autonomous vehicle may be offloaded to the secure data storage 122.

The autonomous vehicle maintenance/repair kit 124 may include any tools and/or components for performing autonomous vehicle maintenance. The autonomous vehicle maintenance/repair kit 124 may include devices to calibrate sensors (e.g., of the sensor subsystem 544 of autonomous vehicle 502 shown in FIG. 5). In some cases, the mobile terminal system 100 may be configured to perform roaming maintenance, as described in greater detail with respect to FIGS. 2 and 4 below. For example, after a terminal site is established, the mobile terminal system 100 may receive a request for maintenance along an autonomous vehicle route (e.g., a route 204, 214 of FIG. 2). The vehicle of the mobile terminal system 100 can then travel to the autonomous vehicle in need of repair and an operator or technician can use the autonomous vehicle maintenance/repair kit 124 to efficiently repair and help relaunch the autonomous vehicle. The autonomous vehicle maintenance/repair kit 124 may include tools for inspecting autonomous vehicles. In some cases, results form an inspection may be provided to the control subsystem 102, which in turn may provide the inspection results to a centralized fleet management system (e.g., to fleet management system 208 of FIG. 2).

The portable device(s) 126 are generally smart phones, tablets, or other handheld and/or lightweight devices that can be operated within a deployed terminal site. Portable devices 126 may receive alerts or other notifications from the control subsystem 102 about actions to be taken to improve reliability and efficiency of operations in a terminal site. For example, a portable device 126 may receive an alert indicating an incoming autonomous vehicle, such that a user of the portable device 126 can begin preparation for inspection and unloading of the autonomous vehicle. As another example, a portable device 126 may receive an alert indicating that a launchpad is not clear for an autonomous vehicle requesting to exit a terminal site. The user of the portable device 126 can then take actions to clear the area around the launchpad (see FIG. 3). As further examples, portable devices 126 may receive alerts of incoming autonomous vehicles, access autonomous vehicle route schedules, provide information for supporting inspection and/or verification of autonomous vehicle readiness prior to departure. The portable devices 126 can provide a user visibility to the health and/or locations of autonomous vehicles or associated trailers. In some cases, the portable devices 126 can host application services that support the operation of an autonomous vehicle fleet from a terminal during preparation of departure and/or arrival. The portable devices 126 can support workflows to improve the efficiency of terminal operations.

The site setup kits 128 includes materials for establishing landing pads and launchpads (see landing pad/launchpad 310 of FIG. 3). The site setup kits 128 may include position delineators or markers 130. The position markers 130 may include traffic cones, traffic barriers, paint, and anything else that can provide a visual and/or physical separation of regions within a space. The site setup kits 128 may include sensors 312, 316, 320 that can be deployed within a terminal site to improve autonomous vehicle performance within the site (see FIG. 3). Items in the site setup kit 128 may be foldable, expandable, and/or modular as necessary to fit within available space of vehicle 132. Other items in the site setup kit 128 may include tools for facilitating site management, such as lights, security cameras, tents (or other shade-providing structures), chairs, space heaters or coolers, fans, portable restroom facilities, and the like. Other equipment 106 may be used for vehicle and trailer inspections. For example, the equipment 106 may include components to setup a weigh station in a terminal site. As described above, results form an inspection using equipment 106 may be provided to the control subsystem 102, which in turn may provide the inspection results to a centralized fleet management system (e.g., fleet management system 208 of FIG. 2). A third party can be called in to provide refueling at a mobile terminal site established using the mobile terminal system 100.

### Terminal Routing and Fleet Management

FIG. 2 illustrates an autonomous vehicle fleet system 200 operating in a geographic region in which a number of terminal sites 202, 206, 216 are deployed using the mobile terminal system 100 of FIG. 1. The region of the autonomous vehicle fleet system 200 incudes a first terminal site 202, a second terminal site 206, and a third terminal site 216. A terminal site 202, 206, 216 may be an operational yard that supports loading and/or unloading of items from autonomous vehicles 502, weighing autonomous vehicles 502, inspecting autonomous vehicles 502, repairing autonomous vehicles 502, and the like. Terminal site 202, 206, 216 may include resources to prepare autonomous vehicles 502 to travel to other locations (e.g., one of the other terminal sites 202, 206, 216 shown in FIG. 2 or another destination). The terminal sites 202, 206, 216 are not limited to specific physical structures and pre-constructed locations or buildings. Further details of an example terminal site 202, 206, 216 are described with respect to FIG. 3 below.

autonomous vehicles 502 can travel autonomously between terminal sites 202, 206, 216 using routes 204, 214, which may have been determined by the mobile terminal system 100. For example, when the mobile terminal system 100 traveled along routes 204, 214 to establish the various terminal sites 202, 206, 216, sensors 104 may have generated route data 120. As described above, the route data 120 may include a location of the newly established terminal sites 202, 206, 216, geographic coordinates of a route 204, 214, information about obstructions along a route 204, 214, information about traffic along a route 204, 214, information about lane or road closures along a route 204, 214, and the like. The route data 120 may be provided from the mobile terminal system 100 to autonomous vehicles 502 in a fleet traveling in a given geographical region and/or to a fleet management system 208 that helps track and manage movements of autonomous vehicles 502 in the region. The fleet management system 208 is described in greater detail below.

In the example of FIG. 2, the first terminal site 202 has already been established by the mobile terminal system 100, and the mobile terminal system 100 is no longer in the first terminal site 202. Instead, the mobile terminal system 100 has travelled to a location of a second terminal site 206 and established, or deployed, the second terminal site 206 using equipment 106. The location of new terminal site 206 may be any suitable location (e.g., suitably flat, free of obstruction, near to roadways/cargo receiving locations) where there is a need for increased support of autonomous vehicles 502.

In some cases, a request may have been sent for the mobile terminal system 100 to establish terminal site 206 at a corresponding location. In some cases, the location for terminal site 206 may have been determined at least in part based on fleet management data 114. The fleet management data 114 may indicate that autonomous vehicles 502 need additional support in the location where terminal site 206 is established. For example, if the fleet management data 114 indicates increased traffic of autonomous vehicles 502 in a location that lacks sufficient terminal capacity, the new mobile terminal site 206 may be deployed at this location using the mobile terminal system 100. Fleet management data 114 may be provided from autonomous vehicles 502 of the fleet and/or from the fleet management system 208. As a further example, a mobile terminal system 100 may be deployed to establish new terminal site 206 when route 204 needs one or more temporary support terminal sites, either due to lack of permanent terminals or to support a short-term increase in fleet size (e.g., increase in transportation demand). The mobile terminal system 100 is capable of efficiently and rapidly establishing these supporting terminal sites 202, 206, 216 to meet these short-term or dynamic needs. In general, the mobile terminal system 100 allows the full functionality of a conventional terminal to be deployed rapidly in any available and appropriate location. A conventional terminal requires a long lead time and high costs to install more permanent infrastructure.

When the vehicle 132 of the mobile terminal system 100 travels along route 204 to reach the location of the second terminal site 206 from the first terminal site 202, route data 120 is collected for the route 204. Route data 120 may include geographic coordinates of a route 204, 214 (e.g., from a GPS transceiver of sensors 104 of the mobile terminal system 100), information about obstructions along a route 204, 214 (e.g., from cameras, LIDAR, or RADAR of sensors 104 of the mobile terminal system 100), information about traffic along a route 204, 214, information about lane or road closures along a route 204, 214 (e.g., from cameras, LIDAR, or RADAR of sensors 104 of the mobile terminal system 100), and the like. This route data 120 allows autonomous vehicles 502 to travel to the new terminal site 206 more reliably and efficiently than currently possible.

After the vehicle 132 reaches the location of terminal site 206, equipment 106 from the mobile terminal system 100 is used to establish the terminal site 206. For example, the site setup kits 128 may be used to establish the new terminal site 206 as described above with respect to FIG. 1. For instance, position markers 130 may be deployed to designate different regions within the space of the terminal site 206, including the landing pad(s) and/or launchpads (see landing pads/launchpads 310 of FIG. 3). Sensors 312, 316, 320 may be deployed within the terminal site 206 to aid in efficiently and reliably directing movements of autonomous vehicles 502 in the terminal site 206 (see also FIG. 3). Other equipment 106, such as lights, security cameras, tents (or other shade-providing structures), chairs, space heaters or coolers, fans, portable restroom facilities, and the like, may also be deployed in the new terminal site 206.

As an autonomous vehicle 502 is incoming, the control subsystem 102 provides landing instructions 116 to the autonomous vehicle 502. As described above and further with respect to FIGS. 3 and 4 below, the landing instructions 116 indicate movements that an incoming autonomous vehicle 502 can perform to reach a landing pad in the terminal site 206. While the autonomous vehicle 502 is incoming to the terminal site 206, portable devices 126 may receive alerts or other notifications from the control subsystem 102 about actions to be taken to improve safety and efficiency of operations in a terminal site. For example, a portable device 126 may receive an alert indicating an incoming autonomous vehicle to prepare for inspection and unloading of the autonomous vehicle 502.

When the incoming autonomous vehicle 502 lands in the landing pad at the terminal site 206, secure data storage 122 may be used to offload data from the autonomous vehicle 502. The autonomous vehicle maintenance/repair kit 124 may be used to inspect the autonomous vehicle 502, make any necessary repairs to the autonomous vehicle 502, and/or calibrate sensors of the autonomous vehicle 502 (e.g., of the sensor subsystem 544 shown in FIG. 5). When the autonomous vehicle 502 is ready to leave the terminal site 206, launch instructions 118 are provided indicating movements for the autonomous vehicle 502 to perform to exit a launchpad and travel out of the terminal site 206. If movement is not clear, a portable device 126 may receive an alert indicating that the launchpad is not clear for movement and appropriate actions may be indicated to efficiently clear the area around the launchpad (see alert 340 and area 326 of FIG. 3).

At some time, the mobile terminal system 100 may receive a request to establish another new terminal site 216 (e.g., based on fleet management data 114 indicating a need for increased support of the fleet of autonomous vehicles 502). The vehicle 132 of the mobile terminal system 100 may travel along route 214 to the location of the new terminal site 216. In some cases, equipment and/or computing resources for operating the control subsystem 102 may be left behind at terminal site 206, such that terminal site 206 can continued to operate. While the vehicle 132 travels to the new terminal site 216, route data 120 is collected as described above with respect to route 204. An example terminal site 216 is shown in FIG. 3 and described in greater detail below.

At some time, the mobile terminal system 100 may receive a request to generate updated route data 120 for one or more of the routes 204, 214. For example, after a predetermined time interval (e.g., certain number of days or weeks) or if issues with autonomous vehicle 502 travel have been detected, the vehicle 132 of the mobile terminal system 100 may travel along a route 204, 214 to generate new route data 120 for the route 204, 214. This new route data 120 may capture any changes to the route 204, 214. For example, the new route data 120 may reflect changes in traffic, obstructions, closed lanes, change in GPS coordinates for the route 204, 214 (e.g., because of detours or road construction), and the like.

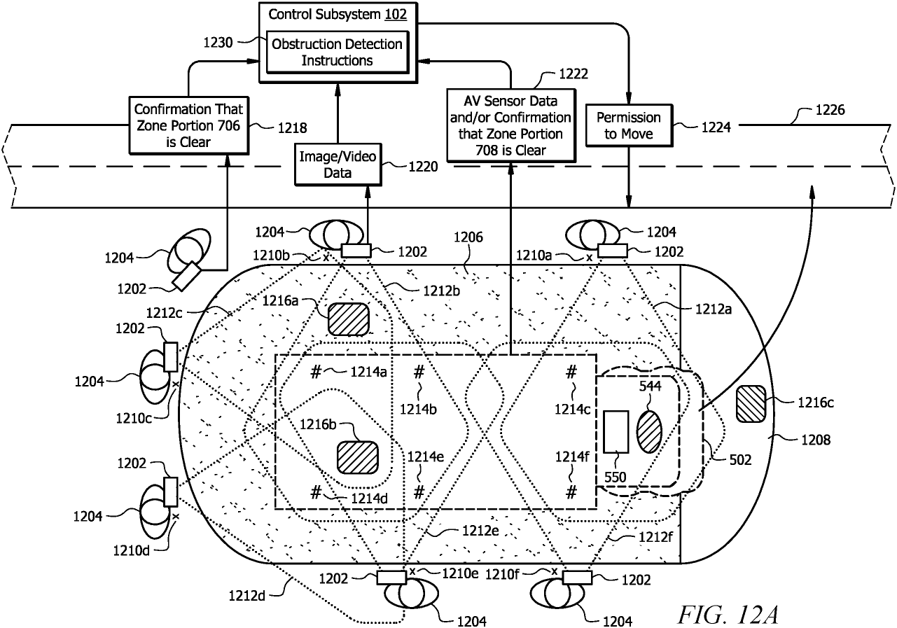

At some time, the mobile terminal system 100 may receive a request for roaming or out-of-terminal maintenance of an autonomous vehicle 502 located somewhere near to or along a route 204, 214. For example, after a terminal site 202, 206, 216 is established, the mobile terminal system 100 may receive a request for maintenance along an autonomous vehicle route 204, 214. The vehicle of the mobile terminal system 100 can then travel to (e.g., be driven to) the autonomous vehicle 502 in need of repair and repairs can be performed. The mobile terminal system 100 may help relaunch the repaired autonomous vehicle 502. Further details of performing out-of-terminal maintenance and relaunching an autonomous vehicle 502 is described with respect to FIGS. 12A,B and 13 below.

The fleet management system 208 shown in FIG. 2 tracks and manages both the deployment of mobile terminal sites 202, 206, 216 and the movements of autonomous vehicles 502. The fleet management system 208 generally manages and tracks movements of the fleet of autonomous vehicles 502 and the mobile terminal system 100 in the region of the autonomous vehicle fleet system 200. For example, the fleet management system 208 may detect when autonomous vehicle traffic in the region of the autonomous vehicle fleet system 200 is greater than a threshold level and initiate the establishment of a rapidly deployed terminal site 202, 206, 216. The fleet management system 208 helps provide visibility of the status, arrival times, and departure times of autonomous vehicles 502 in a fleet. This and other similar information may be used to improve scheduling of fleet movements and deployment of terminal sites 202, 206, 216. Information from the fleet management system 208 may be visible (e.g., to individuals at the terminal sites 202, 206, 216 and/or other locations) to support terminal operations.

The example fleet management system 208 includes a processor 210, memory 212, and communications interface 218. The processor 108 includes one or more processors. The processor 210 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 210 may be a programmable logic device, a microcontroller, a microprocessor, or any suitable combination of the preceding. The processor 210 is communicatively coupled to and in signal communication with the memory 212 and communications interface 218, and sensor(s) 104 (described further below). The one or more processors are configured to process data and may be implemented in hardware and/or software. For example, the processor 210 may be 8-bit, 16-bit, 32-bit, 64-bit or of any other suitable architecture. The processor 210 may include an arithmetic logic unit (ALU) for performing arithmetic and logic operations, processor registers that supply operands to the ALU and store the results of ALU operations, and a control unit that fetches instructions from memory 212 and executes them by directing the coordinated operations of the ALU, registers and other components.

The memory 212 is operable to store fleet management data 114, route data 120, and/or any other data, instructions, logic, rules, or code operable to execute functions of the fleet management system 208. The memory 212 includes one or more disks, tape drives, or solid-state drives, and may be used as an over-flow data storage device, to store programs when such programs are selected for execution, and to store instructions and data that are read during program execution. The memory 212 may be volatile or non-volatile and may comprise read-only memory (ROM), random-access memory (RAM), ternary content-addressable memory (TCAM), dynamic random-access memory (DRAM), and static random-access memory (SRAM).

The communications interface 218 is configured to communicate data between the fleet management system 208 and other devices, systems, or domain(s), such as autonomous vehicles 502 and the mobile terminal system 100. The communications interface 218 is an electronic circuit that is configured to enable communications between devices. For example, the communications interface 218 may be a network interface that includes a cellular communication transceiver, a WIFI interface, a local area network (LAN) interface, a wide area network (WAN) interface, a modem, a switch, and/or a router. The processor 210 is configured to send and receive data using the communications interface 218. The communications interface 218 may be configured to use any suitable type of communication protocol. The communications interface 218 communicates fleet management data 114, and route data 120.

In some cases, landing instructions 116 and/or launch instructions 118 may be communicated through the fleet management system 208. For example, the control subsystem 102 of the mobile terminal system 100 may provide the landing instructions 116 and/or launch instructions 118 to the fleet management system 208, which in turn sends the landing instructions 116 and/or launch instructions 118 to the appropriate autonomous vehicle 502. This approach allows landing instructions 116 and/or launch instructions 118 to reach an autonomous vehicle 502 that might be out of range of direct communications with the mobile terminal system 100.

In some cases, the mobile terminal system 100 may improve communication between autonomous vehicles 502 of the fleet and the fleet management system 208 tasked with managing at least a portion of the operations of the autonomous vehicles 502. For example, if an autonomous vehicle 502 is temporarily unable to communicate with the fleet management system 208, fleet management data 114 from one or more autonomous vehicles 502 located near the mobile terminal system 100 may be provided to the mobile terminal system 100, which then passes the fleet management data 114 to the fleet management system 208. In this way, the mobile terminal system 100 may provide a supplemental communication path between the autonomous vehicles 502 and the fleet management system 208 when direct communication between the autonomous vehicles and fleet management system are slow or unavailable (e.g., if an autonomous vehicle 502 is within communication range of the mobile terminal system 100 but outside a communication range of the fleet management system 208).

### Example Terminal Site

FIG. 3 illustrates an example mobile terminal site 202, 206, 216 of FIG. 2 in greater detail. The example terminal site 202, 206, 216 of FIG. 3 includes a secure area 302 in which the mobile terminal system 100 is located. The secure area 302 may be established, for example, using position markers 130 from the mobile terminal system 100. One or more security cameras may be deployed in or around secure area 302. The secure area 302 also includes an operations tent 304. The operations tent 304 may act as a staging area for operators working in the terminal site 202, 206, 216. Equipment 106, such as computers, chairs, heating/cooling devices, and the like, may be deployed within the operations tent 304. In some cases, all or a portion of the control subsystem 102 is modular and can be removed from the vehicle 132 of the mobile terminal system 100 and operated from the operations tent 304 or some other location within the terminal site 202, 206, 216.

In the example of FIG. 3, the terminal site 202, 206, 216 includes a number of lights 306 arranged around the border of the terminal site 202, 206, 216. These lights 306 may be among the equipment 106 of the mobile terminal system 100. When deployed as shown in FIG. 3, the lights 306 improve safety and security in the terminal site 202, 206, 216.

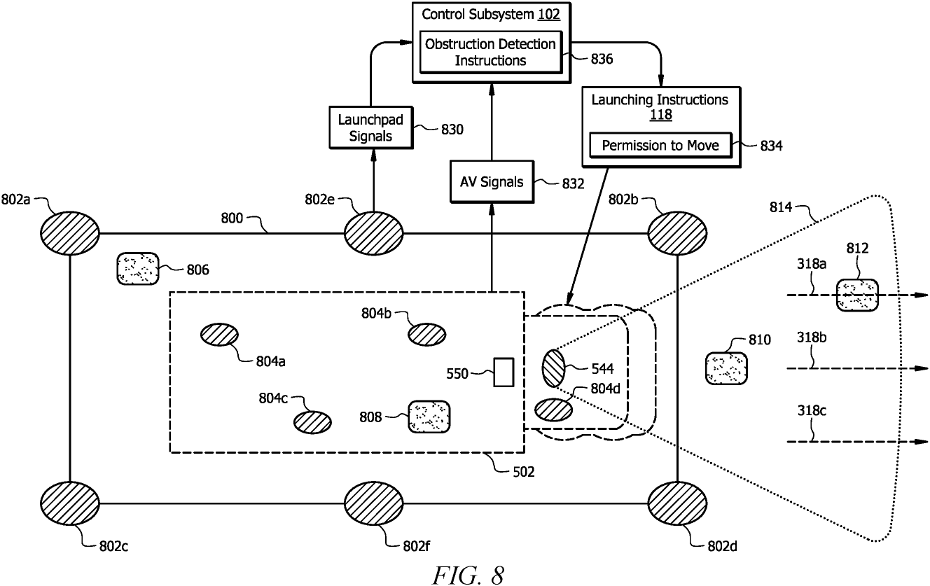

The example terminal site 202, 206, 216 of FIG. 3 is divided into an autonomous vehicle zone 308 where autonomous vehicles 502 primarily operate autonomously and a manual zone 328 where conventional tractor-trailers are handled. The autonomous vehicle zone 308 includes at least one landing pad/launchpad 310. The same space can be used as both a landing pad and launchpad 310, or a separate space may be designated for each. The landing pad(s)/launchpad(s) 310 may be designated using position markers 130 (see FIG. 1 and corresponding description above). The landing pad(s)/launchpad(s) 310 are sized and shaped to accommodate an autonomous vehicle 502. In this example, a land or ready-to-launch autonomous vehicle 502b is shown within the landing pad/launchpad 310. Further details of a landing pad/launch pad 310 are described below with respect to FIGS. 8-11.

In the example of FIG. 3, the landing pad/launchpad 310 includes sensors 312 positioned on, in, or near the landing pad/launchpad 310. As described further below with respect to the example operation of the landing pad/launchpad 310, the sensors 312 may detect movement and/or obstructions within or near the landing pad/launchpad 310. For example, sensors 312 may provide information indicating whether a landing pad/launchpad 310 is currently occupied (e.g., by a vehicle, person, animal, or other object) and/or whether an area 326 around the landing pad/launchpad 310 is free of obstructions (e.g., a vehicle, person, animal, or other object).

One or more in-bound routes 314a-c may be designated (e.g., using position markers 130 of FIG. 1) along which an in-bound autonomous vehicle 502a can travel to reach the landing pad/launchpad 310. A sensor 316 may be positioned on, in, or near the routes 314a-c to detect traffic along these routes 314a-c. This traffic information can be used by the control subsystem 102 to determine a more efficient route 314a-c for an in-bound autonomous vehicle 502a to travel along to reach the landing pad/launchpad 310. The landing instructions 116 may indicate this route 314a-c. For example, if there is an obstruction (e.g., a stopped vehicle) in a first route 314a, the landing instructions 116 may cause an in-bound autonomous vehicle 502a to travel along the second or third route 314b,c to reach the landing pad/launchpad 310. When the in-bound autonomous vehicle 502a executes the landing instructions 116, the autonomous vehicle 502a follows this improved route 314b,c. The landing instructions 116 may be regularly updated to capture changes in traffic (e.g., based on information from sensor 316) and/or occupancy at the landing pad/launchpad 310 (e.g., based on information from sensor(s) 312), such that in-bound autonomous vehicles 502a reliably reach an available landing pad/launchpad 310 via a route 314a-c with little or no traffic, obstructions, or delays.

Similarly to as described above for the in-bound routes 314a-c, one or more out-bound routes 318a-c may be designated (e.g., using position markers 130 of FIG. 1) along which an out-bound autonomous vehicle 502b can travel after exiting the landing pad/launchpad 310. A sensor 320 may be positioned on, in, or near the routes 318a-c to detect traffic along these routes 318a-c. This traffic information can be used by the control subsystem 102 to determine a more efficient route 318a-c for the out-bound autonomous vehicle 502b to travel along to move away from the landing pad/launchpad 310 and reach a roadway corresponding to a route 204, 214 of FIG. 2. The launch instructions 118 may indicate this route 318a-c. For example, if there is an obstruction (e.g., a stopped vehicle) in a first route 318a, the launch instructions 118 may cause the out-bound autonomous vehicle 502b to travel along the second or third route 318b,c to reach a roadway for route 204, 214. When the autonomous vehicle 502b executes the launch instructions 118, the autonomous vehicle 502b follows this improved route 318b,c. The launch instructions 118 may be regularly updated to capture changes in traffic (e.g., based on information from sensor 320) and/or occupancy in the area 326 around the landing pad/launchpad 310 (e.g., based on information from sensor(s) 312), such that an out-bound autonomous vehicle 502a reliably exits the landing pad/launchpad 310 and travels along a route 318a-c with little or no traffic or obstructions.

The manual zone 328 of the terminal site 202, 206, 216 facilitates arrival 332 and departure 334 of vehicles that are not traveling autonomously. A gate tent 330 may be setup in the manual zone 328 using equipment 106 (see FIG. 1). The gate tent 330 provides a space for individuals tasked with monitoring and approving arrival 332 and departure 334 of conventional non-autonomous vehicles. This management and record keeping is performed by the control subsystem 102 for in-bound autonomous vehicles 502a and out-bound autonomous vehicles 502b, thereby providing further improvements to the overall efficiency of autonomous vehicle operations. The manual zone 328 of the terminal would be where autonomous vehicles could be operated in manual mode upon landing or before launching, during the detachment/attachment of a trailer. It is also feasible that the manual side is where the autonomous vehicles 502 can also be operated in a manual mode (e.g., driven by a driver) in the manual zone 328, for example, for minor repairs to the physical/mechanical portion of the autonomous vehicle 502 to be performed.

The terminal site 202, 206, 216 may include separate stage lots 336 and drop lots 338. The stage lots 336 and drop lots 338 may be designated using position markers 130 from the mobile terminal system (see FIG. 1). Stage lots 336 may be areas in which vehicle inspection and maintenance is performed prior to departure of the autonomous vehicle 502b. For example, an out-bound autonomous vehicle 502b and/or its trailer may be inspected at a stage lot 336 and returned to a launchpad 310 prior to autonomous departure of the out-bound autonomous vehicle 502b. Information about an inspection may be entered in an electronic inspection report 342 (e.g., using a portable device 126 from the mobile terminal system 100) and provided to the control subsystem 102. The control subsystem 102 may in turn provide the inspection report 342 to the fleet management system 208 (see FIG. 2) and/or other appropriate parties needing this information. This ease of handling the inspection report 342 may improve the accuracy and availability of inspection information and improve throughput of inspected vehicles in the terminal site 202, 206, 216. A drop lot 338 may be location where items carried by a vehicle (e.g., an in-bound autonomous vehicle 502a) are taken out of the vehicle. For example, a drop lot 338 may be near a location where transported items are needed or will be stored. A third party can be contacted to provide refueling of autonomous vehicles 502 in the terminal site 202, 206, 216 (e.g., in the landing pad/launchpad 310, a stage lot 336, or drop lot 338).

In an example operation of a landing pad 310, a landing request 322 is received for an in-bound autonomous vehicle 502a. The landing request 322 indicates that the autonomous vehicle 502a is in-bound to the terminal site 202, 206, 216. The landing request 322 may be a request for the in-bound autonomous vehicle 502a to be granted permission to stop at the landing pad 310 of the terminal site 202, 206, 216. The landing request 322 may indicate an expected time of arrival of the autonomous vehicle 502a and/or provide information about items transported by the autonomous vehicle 502a, an operator of the autonomous vehicle 502a, and the like. The landing request 322 may be sent when the autonomous vehicle 502a is within a threshold distance from the terminal site 202, 206, 216 and/or when the in-bound autonomous vehicle 502a is traveling along a known route 204, 214 to the terminal site 202, 206, 216.

After receiving the landing request 322, the mobile terminal system 100 (e.g., the control subsystem 102) may determine a landing pad 310 that can accommodate the in-bound autonomous vehicle 502a. For example, the control subsystem 102 may determine a landing pad 310 that is unoccupied or otherwise free of obstructions or other vehicles. Information from sensors 312 may be used to determine an available landing pad 310. The control subsystem 102 may determine a landing pad 310 that is located close to other resources needed by the in-bound autonomous vehicle 502a. For example, if the landing request 322 indicates certain maintenance is required or items are being transported by the autonomous vehicle 502a, then a landing pad 310 near resources for maintenance and/or item unloading facilities may be selected for the in-bound autonomous vehicle 502a. If a landing pad 310 is not available, the control subsystem 102 may initiate activities to clear a landing pad 310 for the in-bound autonomous vehicle 502a by sending an alert 340 (e.g., to a portable device 126 of a technician working in the terminal site 202, 206, 216). The alert 340 may instruct a technician or other individual to clear a landing pad 310. The control subsystem 102 may also determine an in-bound route 314a-c for the in-bound autonomous vehicle 502a to travel along to reach the landing pad 310. For example, movement or traffic information from sensor(s) 316 may be used to select a route 314a-c that is most efficient for the in-bound autonomous vehicle 502a to reach the selected landing pad 310.

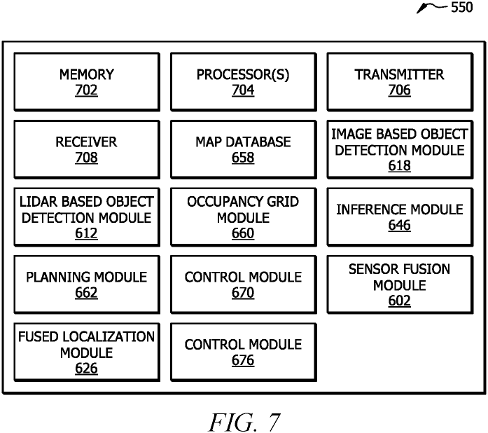

Landing instructions 116 are then provided to the in-bound autonomous vehicle 502a. The landing instructions 116 may indicate the landing pad 310 in which the in-bound autonomous vehicle 502a is to stop and the route 314a-c that autonomous vehicle 502a is to travel along to reach the landing pad 310. In other words, landing instructions 116 may indicate movements that the in-bound autonomous vehicle 502a can perform to reach the landing pad 310. For example, the landing instructions 116, when executed by a control computer of the in-bound autonomous vehicle 502a (see FIGS. 5 and 7), direct at least a portion of the operations and/or movements of the in-bound autonomous vehicle 502a to reach the landing pad 310. Landing instructions 116 may include a time during which the in-bound autonomous vehicle 502a can enter the terminal site 202, 206, 216, a route 314a-c within the terminal site 202, 206, 216 for the autonomous vehicle 502a to move along to reach the landing pad 310 upon entering the terminal site 202, 206, 216, a location of the landing pad 310 within the terminal site 202, 206, 216 (e.g., GPS or other geographical coordinates of the landing pad 310), and/or an identifier of the landing pad 310.

Landing instructions 116 may be updated as needed or at intervals to account for changes to traffic along routes 314a-c and/or changes in occupancy of the landing pad(s) 310. For example, the control subsystem 102 may receive sensor data from movement or traffic sensor(s) 316 indicating an amount of traffic within the terminal site 202, 206, 216. The sensor data may be used to determine updated landing instructions 116 that, when executed by the control system of the autonomous vehicle 502a, cause the autonomous vehicle 502a to reach the landing pad 310 and avoid traffic while traveling to the landing pad 310 (e.g., by following an alternate route 314a-c with less traffic than an initially assigned route 314a-c). As another example, the control subsystem 102 may receive sensor data from the sensor(s) 312 around the landing pad 310 indicating that the landing pad 310 is now occupied. Updated landing instructions 116 may then be determined and provided to the autonomous vehicle 502a that, when executed by the control system of the autonomous vehicle 502a, prevent the autonomous vehicle 502a from entering the landing pad 310 while the landing pad 310 is occupied. For example, the autonomous vehicle 502a may be held until the landing pad 310 is free or sent to another landing pad 310 if one is available.

Around the time landing instructions 116 are determined and/or sent, the control subsystem 102 may initiate activities to prepare for arrival of the in-bound autonomous vehicle 502a by providing an alert 340 to a technician’s portable devices 126 with instructions that indicate actions to prepare for maintenance, inspection, unloading, and the like of the in-bound autonomous vehicle 502a. Furthermore, the control subsystem 102 may determine that the in-bound autonomous vehicle 502a has reached the landing pad 310 (e.g., by receiving confirmation of landing, by determining that the autonomous vehicle 502a is in the landing pad 310 based on a position of the autonomous vehicle 502a, using data from sensor(s) 312, or the like) and provide an alert 340 (e.g., to a portable device 126) to initiate post-landing activities. For example, the alert 340 may instruct a technician to move the autonomous vehicle 502a from the landing pad 310 to a stage lot 336 or drop lot 338 to perform other tasks.

In an example operation of a launchpad 310, a launch request 324 is received for an out-bound autonomous vehicle 502b. A launch request 324 may be sent when the out-bound autonomous vehicle 502b has completed all pre-trip checks and inspections and is ready to begin moving back to the roadway corresponding to route 204, 214. The out-bound autonomous vehicle 502b may be the same vehicle as the in-bound autonomous vehicle 502a or a different vehicle.

After receiving the launch request 324, the control subsystem 102 determines whether the out-bound autonomous vehicle 502b can exit the landing pad 310. For example, the control subsystem 102 may determine whether an area 326 around the autonomous vehicle 502b and launchpad 310 is free of obstructions. This determination may be facilitated by sensors of the out-bound autonomous vehicle 502b (e.g., from sensors 546 of FIG. 5) and/or sensors 312 associated with the launchpad 310. The control subsystem 102 may determine that the area 326 around the launchpad 310 is unoccupied by determining that the area 326 is free of objects, animals, or people preventing movement of the out-bound autonomous vehicle 502b out of the launchpad 310. If the area 326 around the launchpad 310 is not clear, the control subsystem 102 may initiate actions (e.g., by sending an alert to a technician’s portable device 126) to remove an obstruction or otherwise clear the area 326. The control subsystem 102 may also determine an out-bound route 318a-c for the out-bound autonomous vehicle 502b to travel along to move towards a roadway (e.g., route 204, 214). For example, movement or traffic information from sensor(s) 320 may be used to select a route 318a-c that is most efficient for the out-bound autonomous vehicle 502a to reach the roadway with little or no delay.

Launch instructions 118 are then sent to the out-bound autonomous vehicle 502b. The launch instructions 118 indicate whether the out-bound autonomous vehicle 502b can exit the launchpad 310 and a route 318a-c for the autonomous vehicle 502b to travel along to exit the terminal site 202, 206, 216. In other words, launch instructions 118 may indicate movements that the out-bound autonomous vehicle 502b can perform to exit the launchpad 310. For example, launch instructions 118, when executed by a control system of the autonomous vehicle 502b, may direct at least a portion of operations or movements of the out-bound autonomous vehicle 502b to leave the launchpad 310 and reach a roadway (e.g., corresponding to route 204, 214). The launch instructions 118 may include a time during which the out-bound autonomous vehicle 502b can depart from the launchpad 310 and/or a route 318a-c within the terminal site 202, 206, 216 along which the out-bound autonomous vehicle 502b is to travel to move away from the launchpad 310.

The launch instructions 118 may be updated as needed or at intervals to account for changes to traffic along routes 318a-c and/or changes in occupancy of the area 326 around the launchpad 310. For example, the control subsystem 102 may receive sensor data from sensor(s) 312 indicating the area 326 around the launchpad 310 is now occupied and provide updated launch instructions 118 that, when executed by the control system of the out-bound autonomous vehicle 502b, prevent the out-bound autonomous vehicle 502b from departing from the launchpad 310 while the area 326 is occupied. As another example, the control subsystem 102 may receive sensor data from movement or traffic sensors 320 indicating an amount of traffic within the established terminal site 202, 206, 216 (e.g., along a given route 318a-c) and determine updated launch instructions 118 that, when executed by the control system of the out-bound autonomous vehicle 502b, cause the out-bound autonomous vehicle 502b to move away from the launchpad along a route 318a-c that avoids traffic. For instance, the updated launch instructions 118 indicate an alternate route 318a-c for the out-bound autonomous vehicle 502b to travel along to move away from the launchpad 310.

### Example Operation of a Mobile Terminal System

FIG. 4 illustrates an example process 400 for operating the mobile terminal system 100 of this disclosure. Process 400 generally facilitates improved operation of autonomous vehicles 502 by increasing the efficiency and reliability of autonomous vehicle movements within a terminal site 202, 206, 216. The process 400 may begin at step 402 where the mobile terminal system 102 maps the route to a terminal site 202, 206, 216. For example, a GPS of the sensors 104 of the mobile terminal system 100 may generate or collect route data 120 for a route 204, 214 that the autonomous vehicles 502 of a fleet can travel along to reach a terminal site 202, 206, 216. As described above with respect to FIGS. 1 and 2, route data 120 may include data collected by sensors 104, such as geographical coordinates, road condition information, obstructions to travel, traffic, etc. At step 404, the route data 120 is provided for access by autonomous vehicles 502 of the fleet. The route data 120 may be communicated to autonomous vehicles 502 and/or provided to the fleet management system 208, which allows the autonomous vehicles 502 to access the route data 120 when needed.

At step 406, a terminal site 202, 206, 216 is setup using the equipment 106 of the mobile terminal system 100. Setup of a terminal site 202, 206, 216 is described above with respect to FIG. 3. During setup of the terminal site 202, 206, 216, a landing pad and/or launchpad 310 are established in the terminal site 202, 206, 216. After the terminal site 202, 206, 216 is set up or established, the control subsystem 102 determines whether there is an incoming or in-bound autonomous vehicle 502 at step 408 (see in-bound autonomous vehicle 502a of FIG. 3 and corresponding description above). For example, the control subsystem 102 may determine whether a landing request 322 is received. When an autonomous vehicle 502 is incoming, the control subsystem 102 proceeds to step 410.

At step 410, the control subsystem 102 determines if there is an unoccupied landing pad 310 and a preferred route 314a-c for reaching the landing pad 310 (see example operation of a landing pad 310 with respect to FIG. 3 above). If this is not the case, the control subsystem 102 may proceed to step 412 and identify another space for the incoming autonomous vehicle 502 to land (e.g., a different landing pad 310) or may send an alert 340 to clear a landing pad 310 for the incoming autonomous vehicle 502. Once a landing pad 310 and route 314a-c are determined at step 410, the control subsystem 102 proceeds to step 414.

At step 414, landing instructions 116 are provided to the incoming autonomous vehicle 502. The landing instructions 116 may indicate the landing pad 310 in which the autonomous vehicle 502 is to stop and the route 314a-c for the autonomous vehicle 502 to travel along to reach the landing pad 310. At step 416, the control subsystem 102 may send an alert 340 (e.g., to a portable device 126 of a technician in the terminal site 202, 206, 216) to initiate or prepare for post-landing activities, such as unloading the autonomous vehicle 502, inspecting the autonomous vehicle 502, weighting the autonomous vehicle 502, and the like.

At step 418, the control subsystem 102 determines whether a launch request 324 is received from an autonomous vehicle 502 in a launchpad 310 (see out-bound autonomous vehicle 502b of FIG. 3). When a launch request 324 is received, the control subsystem 102 proceeds to step 420 and determines whether the area 326 is clear (e.g., unoccupied and free of obstructions) and if there is a preferred route 318a-c for exiting the terminal site 202, 206, 216 from the landing pad 310. If this is not the case, the control subsystem 102 may proceed to step 422 to send an alert 340 to clear the area 326 around the launchpad 310 and/or determine an alternate route 318a-c for the autonomous vehicle 502 to travel along to exit the terminal site 202, 206, 216.

Once area 326 is clear and a preferred out-bound route 318a-c is determined, the control subsystem 102 proceeds to step 424 and provides launch instructions 118 to the autonomous vehicle 502. The launch instructions 118 may indicate that the autonomous vehicle 502 can exit the launchpad 310 and the route 318a-c for the autonomous vehicle 502 to travel along to exit the terminal site 202, 206, 216.

At step 426, the control subsystem 102 may determine whether a new terminal site 202, 206, 216 needs to be established. For example, fleet management data 114 may indicate that an additional terminal site 202, 206, 216 is needed to support movements of autonomous vehicles 502 in a given region. The control subsystem 102 may determine this need or the fleet management system 208 may provide instructions indicating this need. As another example, the control subsystem 102 may determine that a short-term terminal site 202, 206, 216 should be established to provide support for a proof-of-concept or temporary route 204, 214. The proof-of-concept or temporary route 204, 214 may be needed because an increase in transportation volume is detected in a region of the short-term terminal site 202, 206, 216 and/or a need is detected for support of the fleet of autonomous vehicles 502 within less than one week (e.g., or less) from a current time. If a new terminal site 202, 206, 216 needs to be established, the control subsystem 102 may return to step 402 to restart the process 400 for a new terminal site 202, 206, 216.

At step 428, the control subsystem 102 may determine whether to remap a route 204, 214 to one or more of the terminal sites 202, 206, 216. For example, after a predefined time interval (e.g., of days, weeks, etc.), a route 204, 214 may be remapped. If a route 204, 214 should be remapped, the control subsystem 102 proceeds to step 430 and remaps the route 204, 214. For example, the vehicle 132 may travel along the route 204, 214 and collect updated route data 120 to address any possible changes to the route 204, 214.

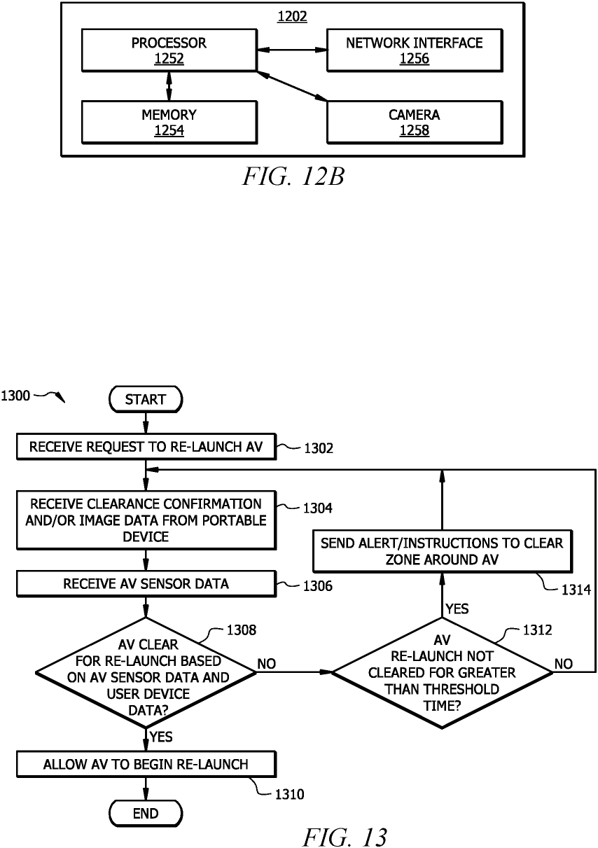

At step 432, the control subsystem 102 determines whether a request for out-of-terminal (e.g., roaming) maintenance is received. If such a request is received, the control subsystem 102 may provide a confirmation that support will be arriving at step 434. The vehicle 132 may travel to a location of the out-of-terminal maintenance and equipment 106 can be used to repair and/or recalibrate an autonomous vehicle 502 at the location. The mobile terminal system 100 may help relaunch the repaired autonomous vehicle 502, for example, as described with respect to FIGS. 12A and 13 below.

### Example Autonomous Vehicle and Autonomous Vehicle Operation

FIG. 5 shows a block diagram of an example vehicle ecosystem 500 in which autonomous driving operations can be determined. As shown in FIG. 5, the autonomous vehicle 502 may be a semi-trailer truck. The vehicle ecosystem 500 includes several systems and components that can generate and/or deliver one or more sources of information/data and related services to the in-vehicle control computer 550 that may be located in an autonomous vehicle 502. The in-vehicle control computer 550 can be in data communication with a plurality of vehicle subsystems 540, all of which can be resident in the autonomous vehicle 502. A vehicle subsystem interface 560 is provided to facilitate data communication between the in-vehicle control computer 550 and the plurality of vehicle subsystems 540. In some embodiments, the vehicle subsystem interface 560 can include a controller area network (CAN) controller to communicate with devices in the vehicle subsystems 540.

The autonomous vehicle 502 may include various vehicle subsystems that support of the operation of autonomous vehicle 502. The vehicle subsystems may emergency stop button 504, a vehicle drive subsystem 542, a vehicle sensor subsystem 544, and/or a vehicle control subsystem 548. The components or devices of the vehicle drive subsystem 542, the vehicle sensor subsystem 544, and the vehicle control subsystem 548 shown in FIG. 5 are examples. The autonomous vehicle 502 may be configured as shown or any other configurations.

The emergency stop button 504 may include a physical button that is configured to disconnect or disengage the autonomous functions of the autonomous vehicle 502 upon being activated. The emergency stop button 504 is in signal communication with the plurality of vehicle subsystems 540 and in-vehicle control computer 550. The emergency stop button 504 may be activated by any appropriate method, such as, by pressing down, pulling out, sliding, switching, using a key, etc. When activated, the emergency stop button 504 may start the fail-safe sequence to disengage the autonomous functions of the autonomous vehicle 502. In this process, when the emergency stop button 504 is activated, it disconnects vehicle drive subsystems 542, vehicle sensor subsystems 544, and vehicle control subsystem 548 from in-vehicle control computer 550. In other words, when the emergency stop button 504 is activated, it cuts the power from the autonomous systems of the autonomous vehicle 502. In one embodiment, when the emergency stop button 504 is activated, the engine/motor 542a may be turned off, brake units 548b may be applied, and hazard lights may be turned on. Upon activation, the emergency stop button 504 may override all related start sequence functions of the autonomous vehicle 502.

The vehicle drive subsystem 542 may include components operable to provide powered motion for the autonomous vehicle 502. In an example embodiment, the vehicle drive subsystem 542 may include an engine/motor 542a, wheels/tires 542b, a transmission 542c, an electrical subsystem 542d, and a power source 542e.

The vehicle sensor subsystem 544 may include a number of sensors 546 configured to sense information about an environment or condition of the autonomous vehicle 502. The vehicle sensor subsystem 544 may include one or more cameras 546a or image capture devices, a Radar unit 546b, one or more temperature sensors 546c, a wireless communication unit 546d (e.g., a cellular communication transceiver), an inertial measurement unit (IMU) 546e, a laser range finder/LiDAR unit 546f, a Global Positioning System (GPS) transceiver 546g, and/or a wiper control system 546h. The vehicle sensor subsystem 544 may also include sensors configured to monitor internal systems of the autonomous vehicle 502 (e.g., an O₂ monitor, a fuel gauge, an engine oil temperature, etc.).

The IMU 546e may include any combination of sensors (e.g., accelerometers and gyroscopes) configured to sense position and orientation changes of the autonomous vehicle 502 based on inertial acceleration. The GPS transceiver 546g may be any sensor configured to estimate a geographic location of the autonomous vehicle 502. For this purpose, the GPS transceiver 546g may include a receiver/transmitter operable to provide information regarding the position of the autonomous vehicle 502 with respect to the Earth. The Radar unit 546b may represent a system that utilizes radio signals to sense objects within the local environment of the autonomous vehicle 502. In some embodiments, in addition to sensing the objects, the Radar unit 546b may additionally be configured to sense the speed and the heading of the objects proximate to the autonomous vehicle 502. The laser range finder or LiDAR unit 546f may be any sensor configured to sense objects in the environment in which the autonomous vehicle 502 is located using lasers. The cameras 546a may include one or more devices configured to capture a plurality of images of the environment of the autonomous vehicle 502. The cameras 546a may be still image cameras or motion video cameras.

The vehicle control subsystem 548 may be configured to control the operation of the autonomous vehicle 502 and its components. Accordingly, the vehicle control subsystem 548 may include various elements such as a throttle and gear 548a, a brake unit 548b, a navigation unit 548c, a steering system 548d, and/or an autonomous control unit 548e. The throttle 548a may be configured to control, for instance, the operating speed of the engine and, in turn, control the speed of the autonomous vehicle 502. The gear 548a may be configured to control the gear selection of the transmission. The brake unit 548b can include any combination of mechanisms configured to decelerate the autonomous vehicle 502. The brake unit 548b can use friction to slow the wheels in a standard manner. The brake unit 548b may include an Anti-lock brake system (ABS) that can prevent the brakes from locking up when the brakes are applied. The navigation unit 548c may be any system configured to determine a driving path or route for the autonomous vehicle 502. The navigation 548c unit may additionally be configured to update the driving path dynamically while the autonomous vehicle 502 is in operation. In some embodiments, the navigation unit 548c may be configured to incorporate data from the GPS transceiver 546g and one or more predetermined maps so as to determine the driving path (e.g., along the routes 204, 214, 314a-c, 318a-c of FIGS. 2 and 3) for the autonomous vehicle 502. The steering system 548d may represent any combination of mechanisms that may be operable to adjust the heading of autonomous vehicle 502 in an autonomous mode or in a driver-controlled mode.

The autonomous control unit 548e may represent a control system configured to identify, evaluate, and avoid or otherwise negotiate potential obstacles or obstructions in the environment of the autonomous vehicle 502. In general, the autonomous control unit 548e may be configured to control the autonomous vehicle 502 for operation without a driver or to provide driver assistance in controlling the autonomous vehicle 502. In some embodiments, the autonomous control unit 548e may be configured to incorporate data from the GPS transceiver 546g, the Radar 546b, the LiDAR unit 546f, the cameras 546a, and/or other vehicle subsystems to determine the driving path or trajectory for the autonomous vehicle 502.

Many or all of the functions of the autonomous vehicle 502 can be controlled by the in-vehicle control computer 550. The in-vehicle control computer 550 may include at least one data processor 570 (which can include at least one microprocessor) that executes processing instructions 580 stored in a non-transitory computer readable medium, such as the data storage device 590 or memory. The in-vehicle control computer 550 may also represent a plurality of computing devices that may serve to control individual components or subsystems of the autonomous vehicle 502 in a distributed fashion. In some embodiments, the data storage device 590 may contain processing instructions 580 (e.g., program logic) executable by the data processor 570 to perform various methods and/or functions of the autonomous vehicle 502, including those described with respect to FIGS. 1-4 above.

The data storage device 590 may contain additional instructions as well, including instructions to transmit data to, receive data from, interact with, or control one or more of the vehicle drive subsystems 542, the vehicle sensor subsystem 544, and the vehicle control subsystem 548. The in-vehicle control computer 550 can be configured to include a data processor 570 and a data storage device 590. The in-vehicle control computer 550 may control the function of the autonomous vehicle 502 based on inputs received from various vehicle subsystems (e.g., the vehicle drive subsystem 542, the vehicle sensor subsystem 544, and the vehicle control subsystem 548).

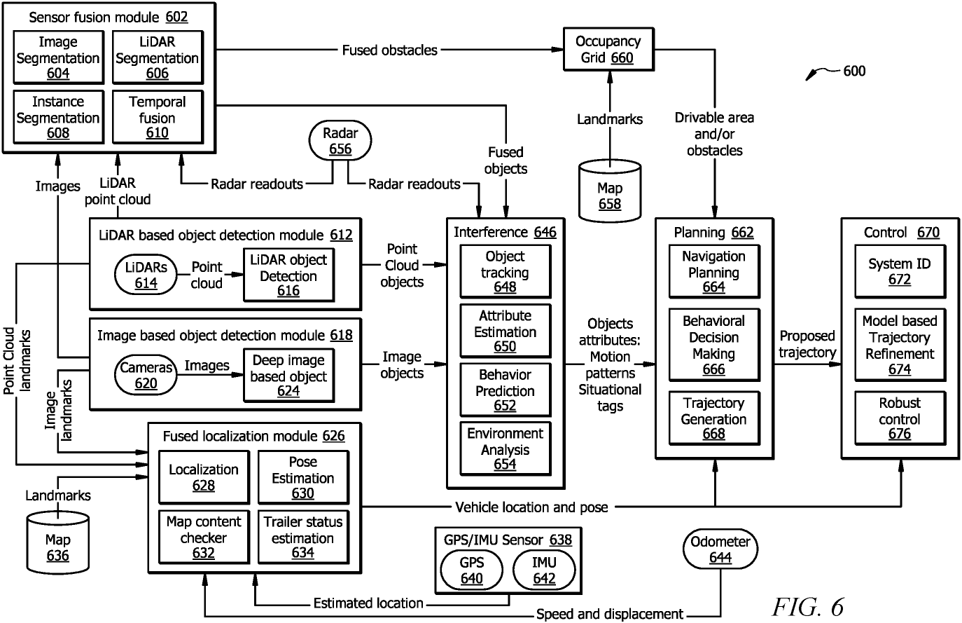

FIG. 6 shows an exemplary system 600 for providing precise autonomous driving operations. The system 600 includes several modules that can operate in the in-vehicle control computer 550, as described in FIG. 5. The in-vehicle control computer 550 includes a sensor fusion module 602 shown in the top left corner of FIG. 6, where the sensor fusion module 602 may perform at least four image or signal processing operations. The sensor fusion module 602 can obtain images from cameras located on an autonomous vehicle 502 to perform image segmentation 604 to detect the presence of moving objects (e.g., other vehicles, pedestrians, etc.,) and/or static obstacles (e.g., stop sign, speed bump, terrain, etc.,) located around the autonomous vehicle 502. The sensor fusion module 602 can obtain LiDAR point cloud data item from LiDAR sensors located on the autonomous vehicle 502 to perform LiDAR segmentation 606 to detect the presence of objects and/or obstacles located around the autonomous vehicle 502.

The sensor fusion module 602 can perform instance segmentation 608 on image and/or point cloud data item to identify an outline (e.g., boxes) around the objects and/or obstacles located around the autonomous vehicle 502. The sensor fusion module 602 can perform temporal fusion 610 where objects and/or obstacles from one image and/or one frame of point cloud data item are correlated with or associated with objects and/or obstacles from one or more images or frames subsequently received in time.

The sensor fusion module 602 can fuse the objects and/or obstacles from the images obtained from the camera and/or point cloud data item obtained from the LiDAR sensors. For example, the sensor fusion module 602 may determine based on a location of two cameras that an image from one of the cameras comprising one half of a vehicle located in front of the autonomous vehicle 502 is the same as the vehicle located captured by another camera. The sensor fusion module 602 sends the fused object information to the interference module 646 and the fused obstacle information to the occupancy grid module 660. The in-vehicle control computer includes the occupancy grid module 660 which can retrieve landmarks from a map database 658 stored in the in-vehicle control computer. The occupancy grid module 660 can determine drivable areas and/or obstacles from the fused obstacles obtained from the sensor fusion module 602 and the landmarks stored in the map database 658. For example, the occupancy grid module 660 can determine that a drivable area may include a speed bump obstacle.

Below the sensor fusion module 602, the in-vehicle control computer 550 includes a LiDAR based object detection module 612 that can perform object detection 616 based on point cloud data item obtained from the LiDAR sensors 614 located on the autonomous vehicle 502. The object detection 616 technique can provide a location (e.g., in 3D world coordinates) of objects from the point cloud data item. Below the LiDAR based object detection module 612, the in-vehicle control computer includes an image-based object detection module 618 that can perform object detection 624 based on images obtained from cameras 620 located on the autonomous vehicle 502. The object detection 624 technique can employ a deep machine learning technique 624 to provide a location (e.g., in 3D world coordinates) of objects from the image provided by the camera 620.

The Radar 656 on the autonomous vehicle 502 can scan an area in front of the autonomous vehicle 502 or an area towards which the autonomous vehicle 502 is driven. The Radar data is sent to the sensor fusion module 602 that can use the Radar data to correlate the objects and/or obstacles detected by the Radar 656 with the objects and/or obstacles detected from both the LiDAR point cloud data item and the camera image. The Radar data is also sent to the interference module 646 that can perform data processing on the Radar data to track objects by object tracking module 648 as further described below.

The in-vehicle control computer includes an interference module 646 that receives the locations of the objects from the point cloud and the objects from the image, and the fused objects from the sensor fusion module 602. The interference module 646 also receives the Radar data with which the interference module 646 can track objects by object tracking module 648 from one point cloud data item and one image obtained at one time instance to another (or the next) point cloud data item and another image obtained at another subsequent time instance.

The interference module 646 may perform object attribute estimation 650 to estimate one or more attributes of an object detected in an image or point cloud data item. The one or more attributes of the object may include a type of object (e.g., pedestrian, car, or truck, etc.). The interference module 646 may perform behavior prediction 652 to estimate or predict motion pattern of an object detected in an image and/or a point cloud. The behavior prediction 652 can be performed to detect a location of an object in a set of images received at different points in time (e.g., sequential images) or in a set of point cloud data item received at different points in time (e.g., sequential point cloud data items). In some embodiments the behavior prediction 652 can be performed for each image received from a camera and/or each point cloud data item received from the LiDAR sensor. In some embodiments, the interference module 646 can be performed (e.g., run or executed) to reduce computational load by performing behavior prediction 652 on every other or after every pre-determined number of images received from a camera or point cloud data item received from the LiDAR sensor (e.g., after every two images or after every three point cloud data items).

The behavior prediction 652 feature may determine the speed and direction of the objects that surround the autonomous vehicle 502 from the Radar data, where the speed and direction information can be used to predict or determine motion patterns of objects. A motion pattern may comprise a predicted trajectory information of an object over a pre-determined length of time in the future after an image is received from a camera. Based on the motion pattern predicted, the interference module 646 may assign motion pattern situational tags to the objects (e.g., “located at coordinates (x,y),” “stopped,” “driving at 50mph,” “speeding up” or “slowing down”). The situation tags can describe the motion pattern of the object. The interference module 646 sends the one or more object attributes (e.g., types of the objects) and motion pattern situational tags to the planning module 662. The interference module 646 may perform an environment analysis 654 using any information acquired by system 600 and any number and combination of its components.

The in-vehicle control computer includes the planning module 662 that receives the object attributes and motion pattern situational tags from the interference module 646, the drivable area and/or obstacles, and the vehicle location and pose information from the fused localization module 626 (further described below).

The planning module 662 can perform navigation planning 664 to determine a set of trajectories on which the autonomous vehicle 502 can be driven. The set of trajectories can be determined based on the drivable area information, the one or more object attributes of objects, the motion pattern situational tags of the objects, location of the obstacles, and the drivable area information. In some embodiments, the navigation planning 664 may include determining an area next to the road where the autonomous vehicle 502 can be safely parked in case of emergencies. The planning module 662 may include behavioral decision making 666 to determine driving actions (e.g., steering, braking, throttle) in response to determining changing conditions on the road (e.g., traffic light turned yellow, or the autonomous vehicle 502 is in an unsafe driving condition because another vehicle drove in front of the autonomous vehicle 502 and in a region within a pre-determined safe distance of the location of the autonomous vehicle 502). The planning module 662 performs trajectory generation 668 and selects a trajectory from the set of trajectories determined by the navigation planning operation 664. The selected trajectory information is sent by the planning module 662 to the control module 670.

The in-vehicle control computer includes a control module 670 that receives the proposed trajectory from the planning module 662 and the autonomous vehicle 502 location and pose from the fused localization module 626. The control module 670 includes a system identifier 672. The control module 670 can perform a model-based trajectory refinement 674 to refine the proposed trajectory. For example, the control module 670 can applying a filtering (e.g., Kalman filter) to make the proposed trajectory data smooth and/or to minimize noise. The control module 670 may perform the robust control 676 by determining, based on the refined proposed trajectory information and current location and/or pose of the autonomous vehicle 502, an amount of brake pressure to apply, a steering angle, a throttle amount to control the speed of the vehicle, and/or a transmission gear. The control module 670 can send the determined brake pressure, steering angle, throttle amount, and/or transmission gear to one or more devices in the autonomous vehicle 502 to control and facilitate precise driving operations of the autonomous vehicle 502.

The deep image-based object detection 624 performed by the image-based object detection module 618 can also be used detect landmarks (e.g., stop signs, speed bumps, etc.,) on the road. The in-vehicle control computer includes a fused localization module 626 that obtains landmarks detected from images, the landmarks obtained from a map database 636 stored on the in-vehicle control computer, the landmarks detected from the point cloud data item by the LiDAR based object detection module 612, the speed and displacement from the odometer sensor 644 and the estimated location of the autonomous vehicle 502 from the GPS/IMU sensor 638 (i.e., GPS sensor 640 and IMU sensor 642) located on or in the autonomous vehicle 502. Based on this information, the fused localization module 626 can perform a localization operation 628 to determine a location of the autonomous vehicle 502, which can be sent to the planning module 662 and the control module 670.

The fused localization module 626 can estimate pose 630 of the autonomous vehicle 502 based on the GPS and/or IMU sensors 638. The pose of the autonomous vehicle 502 can be sent to the planning module 662 and the control module 670. The fused localization module 626 can also estimate status (e.g., location, possible angle of movement) of the trailer unit based on (e.g., trailer status estimation 634), for example, the information provided by the IMU sensor 642 (e.g., angular rate and/or linear velocity). The fused localization module 626 may also check the map content 632.

FIG. 7 shows an exemplary block diagram of an in-vehicle control computer 550 included in an autonomous vehicle 502. The in-vehicle control computer 550 includes at least one processor 704 and a memory 702 having instructions stored thereupon (e.g., landing instructions 116, launch instructions 118, and processing instructions 580 shown in FIGS. 1, 3, 5, and 6). The instructions, upon execution by the processor 704, configure the in-vehicle control computer 550 and/or the various modules of the in-vehicle control computer 550 to perform the operations described in FIGS. 1-6. The transmitter 706 transmits or sends information or data to one or more devices in the autonomous vehicle 502. For example, the transmitter 706 can send an instruction to one or more motors of the steering wheel to steer the autonomous vehicle 502. The receiver 708 receives information or data transmitted or sent by one or more devices. For example, the receiver 708 receives a status of the current speed from the odometer sensor or the current transmission gear from the transmission. The transmitter 706 and receiver 708 are also configured to communicate with plurality of vehicle subsystems 540 and the in-vehicle control computer 550 described above in FIGS. 5 and 6.

### Example Launchpad and Launchpad Operation

FIG. 8 illustrates an example launchpad 800 in greater detail. Launchpad 800 is an example of a launchpad 310 of FIG. 3. The launchpad 800 includes a predefined zone or space (e.g., within the terminal 202, 206, 216 shown in FIG. 3) that is sized and shaped to accommodate an autonomous vehicle 502 and a set of sensors 802a-f around the perimeter of or within the launchpad 800. Sensors 802a-f are examples of sensors 312 of FIG. 3. Launchpad pad 800 may be sized and shaped to fit a tractor-unit autonomous vehicle 502 and an attached trailer. As an example, the physical extent of the launchpad 800 may be defined at least in part by the sensors 802a-f located around or within the launchpad 800. In some embodiments, the launchpad 800 includes a physical pad (e.g., a concrete pad). In some embodiments, the launchpad 800 includes physical markers (e.g., painted lines) or position markers 130 from equipment 106 around one or more edges or the perimeter of the launchpad 800.

The sensors 802a-f of the launchpad 800 include any sensors capable of detecting objects, motion, and/or sound which may be associated with the presence of an obstruction 806, 808 within the zone of the launchpad 800. For example, the sensors 802 may include cameras, LiDAR sensors, motion sensors, infrared sensors, and the like. The launchpad 800 generally includes a sensor 802a-d at each corner of the launchpad 800 (i.e., in each corner of the example rectangular launchpad 800 illustrated in FIG. 8). In some embodiments, the launchpad 800 may include additional sensors 802e and/or 802f at intermediate positions (e.g., along the length of the launchpad 800) to provide a view for detecting obstructions 806, 808 in regions of the launchpad 800 that are more distant from sensors 802a-d (e.g., regions near the center of the launchpad 800 which may not be visible because of the presence of the autonomous vehicle 502).

One or more of the sensors 802a-f may be positioned at various heights relative to the ground, for example, by attaching the sensors 802a-f to a support structure, such as a pole. Positioning sensors 802a-f above the ground may provide for improved detection of obstructions 806, 808 that are above the ground such as objects attached to the side of an autonomous vehicle 502, animals on or around the autonomous vehicle 502, and the like. In some embodiments, sensors 802a-f are positioned at multiple heights relative to the ground. For example, one or more of the sensors 802a-f illustrated in FIG. 8 may represent a ground-level sensor, a mid-level sensor, and/or a high-level sensor. For example, a ground-level sensor 802 may be positioned at or near the level of the ground such that the ground-level sensor may detect obstructions 806, 808 within its field-of-view that encompasses a region at or near the ground (e.g., from the level of the ground to a few feet above the ground). A mid-level sensor 802 may be positioned at an intermediate height relative to the ground (e.g., at a height near the center point between the ground and the top of the autonomous vehicle 502), such that the mid-level sensor has a field-of-view that encompasses a region near the middle of the autonomous vehicle 502 (e.g., from near the ground to near the top of the autonomous vehicle 502). A high-level sensor 802 may be placed above the mid-level sensor, for example, to detect obstructions 806, 808 at increased heights relative to the ground and/or to provide a more top-down view of portions of the launchpad 800.

In some embodiments, the launchpad 800 includes one or more additional sensors 804a-d on or within the surface of the launchpad 800. Sensors 804a-d are examples of sensors 312 of FIG. 3. For example, sensors 804a-d may be configured to provide a view underneath an autonomous vehicle 502 located in the launchpad 800. Like sensors 802a-f, the sensors 804a-d may include any appropriate type of sensors for detecting an obstruction 806, 808. For example, the sensors 804a-d may include cameras, LiDAR sensors, motion sensors, infrared sensors, and the like. Sensors 804a-d may particularly facilitate the detection of an obstruction, such as obstruction 808, that is near the center of the launchpad 800 and/or is below the autonomous vehicle 502 that is parked on the launchpad 800. In some cases, such an obstruction 808 may not be detected by other sensors 802a-f. While the example launchpad 800 of FIG. 8 shows six sensors 802a-f and four sensors 804a-d, it should be understood that a launchpad 800 may include any appropriate number, combination, and placement of sensors 802a-f and/or 804a-d.

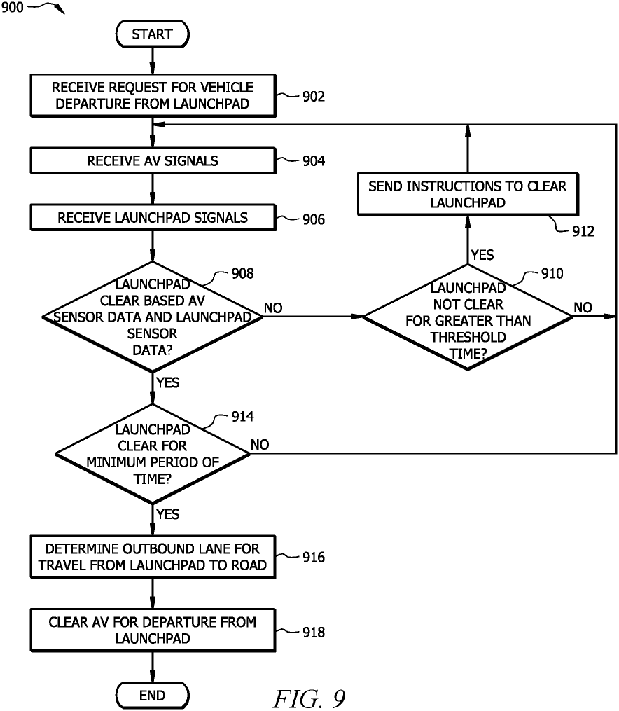

The sensors 802a-f and 804a-d of the launchpad 800 are in signal communication with the control subsystem 102. As described further with respect to the example operation below and the method 900 of FIG. 9, the sensors 802a-f, 804a-d generally communicate launchpad signals 218 to the control subsystem 102. The control subsystem 102 generally receives these signals 830 and uses the signals 830 to determine whether an obstruction 806, 808 is detected within the zone of the launchpad 800. The presence of an obstruction 806, 808 generally indicates that it is not safe for the autonomous vehicle 502 to begin moving. As an example, if a sensor 802a-f, 804a-d is a camera, the signal 830 may include a video and/or photo of a portion of the launchpad 800 viewed by the sensor 802a-f, 804a-d (i.e., the portion of the launchpad 800 within the field-of-view of the camera). The control subsystem 102 uses obstruction detection instructions 836 to determine if an obstruction is detected in the video. For example, the obstruction detection instructions 836 may include code for implementing an object detection routine for images corresponding to frames of the video. If an unexpected object is detected (e.g., an object that is not known to be a part of the autonomous vehicle 502), the control subsystem 102 determines that an obstruction 806, 808 is detected in the launchpad. The obstruction detection instructions 836 may similarly include code for implementing approaches to detecting obstructions based on LiDAR data (e.g., based on the detection of an unexpected object in or around the launchpad 800), motion sensor data (e.g., based on the detection of unexpected motion in or around the launchpad 800), sound (e.g., the detection of an unexpected sound near the launchpad 800), infrared data (e.g., based on the detection of an unexpected object in an infrared image), and the like. The obstruction detection instructions 836 may be implemented using the various modules described below with respect to the detection of objects and obstacles by the autonomous vehicle 502 (see FIG. 6 and corresponding description above).

The control subsystem 102 also receives signals 832 from the autonomous vehicle 502. The control subsystem 102 generally uses these signals 832 to determine that a zone 814 in front of the autonomous vehicle 502 (e.g., a zone or region 814 defined at least in part by a field-of-view of the sensors of the vehicle sensor subsystem 544) is free of obstructions 810, 812. These autonomous vehicle signals 832 may be signals from the vehicle sensor subsystem 544 of the autonomous vehicle 502 and/or communication from the in-vehicle control computer 550 of the autonomous vehicle 502. For example, the signal 832 may be a feed of images, LiDAR data, or the like obtained by the vehicle sensor subsystem 544 of the autonomous vehicle. In such cases, the control subsystem 102 may use the obstruction detection instructions 836 to determine whether an obstruction 810, 812 is detected in the zone 814 in front of the autonomous vehicle 502. In other cases, the autonomous vehicle signal 832 may include an indication of whether or not the in-vehicle control computer 550 has detected an obstruction 810, 812 in front of the autonomous vehicle 502 (see FIG. 6 and corresponding description above). If the control subsystem 102 determines both that the launchpad 800 is free of obstructions 806, 808 based on the launchpad signals 830 and that the zone 814 in front of the autonomous vehicle 502 is free of obstructions 810, 812 based on signals 832, the controls subsystem 102 communicates launch instructions 118 that include a permission 816 for the autonomous vehicle 502 to begin moving out of the launchpad 800. The control subsystem 102 may further identify an outbound lane 318a-c that the autonomous vehicle 502 is to follow to exit the terminal 202, 206, 216 and being traveling along its route 204, 214. For example, an outbound lane 318a-c may be selected that leads to a preferred starting point for the autonomous vehicle’s route 204, 214 and/or based on other traffic in the terminal.

In an example operation of the launchpad 800, the control subsystem 102 may receive a request for the autonomous vehicle 502 to depart from the launchpad 800. In response to the request for departure, the control subsystem 102 determines, based at least in part upon the received launchpad sensor signals 830 (i.e., data included in signals 830), whether the launchpad 800 is free of obstructions that would prevent departure from the launchpad 800. For example, if the sensors 802a-f and/or 804a-d include cameras, the launchpad signals 830 may include images and/or video. In such cases, the control subsystem 102 may employ obstruction detection instructions 836 which include rules for detecting objects in the images and/or video and determining whether the detected objects correspond to obstructions 806, 808. For example, one or more predetermined methods of object detection (e.g., employing a neural network or method of machine learning) may be used to detect objects and determine whether a detected object corresponds to an obstruction 806, 808. Signals from infrared sensors 802a-f and/or 804a-d may be similarly evaluated to detect portions of infrared images with heat signatures associated with the presence of animals and/or people within the zone of the launchpad 800.

As another example, if the sensors 802a-f, 804a-d include LiDAR sensors, the launchpad signals 830 may include distance measurements. In such cases, the control subsystem 102 may employ obstruction detection instructions 836 which include rules for detecting obstructions 806, 808 based on characteristics and/or changes in the distance measurements. For example, changes in distances measured by a LiDAR sensor may indicate the presence of an obstruction 806, 808. For example, each LiDAR sensor may be calibrated to provide an initial distance measurement for when the launchpad 800 is known to be free of obstructions 806, 808. If the distance reported by a given LiDAR sensor changes from this initial value, an obstruction 806, 808 may be detected.

As yet another example, if the sensors 802a-f and/or 804a-d include motion sensors, the launchpad signals 830 may include motion data for the launchpad 800. In such cases, the control subsystem 102 may employ obstruction detection instructions 836 which include rules for detecting obstructions 806, 808 based on detected movement. For example, movement or motion detected within the zone of a launchpad 800 may be caused by the presence of an animal or person within the zone of the launchpad 800. Thus, if motion is detected within the zone of the launchpad 800, then the control subsystem 102 may determine that an obstruction 806 or 808 is detected within the zone of the launchpad 800. In some cases, before an obstruction 806, 808 is detected based on motion, detected movement may need to persist for at least a threshold period of time (e.g., fifteen seconds or more) to reduce or eliminate the false positive detection of obstructions 806, 808 caused by wind and/or other transient events (e.g., an animal, person, or vehicle passing through and immediately leaving the zone of the launchpad 800).

As a further example, if the sensors 802a-f and/or 804a-d include microphones for recording sounds in or around the launchpad 800, the launchpad signals 830 may include such sound recordings. In such cases, the control subsystem 102 may employ obstruction detection instructions 836 which include rules for detecting obstructions 806, 808 based on characteristics of the recorded sounds. For example, a sound corresponding to a person speaking, a vehicle operating or undergoing maintenance, or an animal making a characteristic sound may be evidence that an obstruction 806, 808 may be within the zone of the launchpad 800.

While certain examples of the detection of obstructions 806, 808 are described above, it should be understood that any other appropriate method of obstruction detection may be used by the control subsystem 102. In some embodiments, the control subsystem may use two or more types of sensor data to determine whether an obstruction 806, 808 is detected (e.g., by combining camera images and LiDAR data as described with respect to the sensor fusion module 602 of FIG. 6). For example, obstructions 806, 808 may be detected using the methods and/or modules described for the detection of objects and obstacles by the autonomous vehicle 502 (see FIG. 6 and corresponding description above). In other words, the obstruction detection instructions 836 may include instructions, rules, and/or code for implementing any of the modules described below with respect to FIG. 6.

The control subsystem 102 also determines, based at least in part on the received autonomous vehicle signal 832, whether the region 814 in front of the autonomous vehicle 502 is clear of obstructions 810, 812 that would prevent movement of the autonomous vehicle 502 away from the launchpad 800. For example, the same or similar approaches to those described above for detecting obstructions 806, 808 may be employed to detect obstructions 810, 812 in the region 814 in front of the autonomous vehicle 502.

In the case where it is determined that both the launchpad 800 is free of obstructions 806, 808 that would prevent departure of the autonomous vehicle 502 from the launchpad 800 and that the region 814 in front of the autonomous vehicle 502 is clear of obstructions 810, 812 that would prevent movement of the autonomous vehicle 502 away from the launchpad 800, the control subsystem 102 sends instructions 118 which include permission 816 for the autonomous vehicle 502 to being driving autonomously. Alternatively, for the case where it is determined that one or both of the launchpad 800 is not free of obstructions 806, 808 that would prevent departure of the autonomous vehicle 502 from the launchpad 800 and the region 814 in front of the autonomous vehicle 502 is not clear of obstructions 810, 812 that would prevent movement of the autonomous vehicle 502 away from the launchpad 800, the control subsystem 102 sends instructions 118 which include a denial 818 of permission to begin driving autonomously.

FIG. 9 illustrates an example method 900 of using the launchpad 800 of FIG. 8. The method 900 may be implemented by the launchpad 800 and control subsystem 102. The method 900 may begin at step 902 where the control subsystem 102 receives a request for departure of the autonomous vehicle 502 from the launchpad 800. The request to depart from the launchpad 800 may occur automatically or in response to an input by a human. For example, a request to begin departure may be automatically provided anytime an autonomous vehicle 502 is present in a launchpad 800. For example, upon determining that movement along route 204, 214 should commence, the autonomous vehicle 502 may submit a request to exit the launchpad 800. As another example, an individual (e.g., an operator of the autonomous vehicle 502 and/or an administrator of the terminal 202, 206, 216) may provide a request to begin movement of the autonomous vehicle 502.

At step 904, the control subsystem receives autonomous vehicle signals 832 from the autonomous vehicle 502. As described above, autonomous vehicle signals 832 may include an indication of whether or not the in-vehicle control computer 550 has detected an obstruction 810, 812 in front of the autonomous vehicle 502 and/or sensor data from one or more sensors of the vehicle sensor subsystem 544. At step 906, the control subsystem 102 receives launchpad signals 830. As described above, the launchpad signals 830 generally include data from the launchpad sensors 802a-f, 804a-d. The launchpad signals 830 may include one or more streams of image data, video data, distance measurement data (e.g., from LiDAR sensors), motion data, infrared data, and the like.

At step 908, the control subsystem 102 determines if the launchpad 800 and the zone 814 in front of the autonomous vehicle 502 are both free of obstructions 806, 808, 810, 812, based on the received autonomous vehicle signals 832 and launchpad signals 830. For example, the control subsystem 102 may determine, based on the launchpad signals 830, if an obstruction 806, 808 is detected within the zone of the launchpad 800 or following completion of autonomous vehicle 502 preparation or pre-trip procedure. For example, the control subsystem 102 uses the obstruction detection instructions 836 to determine if an obstruction 806, 808 is detected based on an image, a video, motion data, LiDAR data, an infrared image, and/or a sound recording included in the launchpad signals 830. Examples of the detection of obstructions 806, 808 in the zone of the launchpad 800 are described above with respect to FIG. 8. The obstruction detection instructions 836 generally include code for implementing approaches to detecting obstructions 806, 808 based on image data, video data, LiDAR data, motion sensor data, sound, infrared data, and the like. The control subsystem 102 also determines, based on the autonomous vehicle signals 832, if an obstruction 810, 812 is detected within the zone 814 in front of the autonomous vehicle 502. As described above, obstructions 810, 812 may be detected by the in-vehicle computer 550 and/or by the control subsystem 102 (i.e., similarly to as described above for the detection of obstructions 806, 808).

If an obstruction 806, 808 is detected within the zone of the launchpad 800 and/or an obstruction 810, 812 is detected in front of the autonomous vehicle 502, the control subsystem 102 determines that the autonomous vehicle 502 is not free to begin moving from the launchpad 800 at step 908, and the control subsystem 102 proceeds to step 910. At step 910, the control subsystem 102 determines whether the launchpad 800 and the region 814 in front of the autonomous vehicle is not free of obstructions 806, 808, 810, 812 for a threshold time period (e.g., of 15 minutes or any other appropriate period of time). If the threshold time has not been reached at step 910, the control subsystem 102 continues to receive the autonomous vehicle signals 832 and launchpad signals 830 to determine if the launchpad 502 becomes clear for departure of the autonomous vehicle 502 at step 908. Otherwise, if the threshold time is reached, the control subsystem 102 may proceed to step 912 where instructions are provided to inspect the launchpad 800 (i.e., to remove detected obstruction(s) 806, 808, 810, 812. For example, the control subsystem 102 may detect a particular obstruction 808 in a particular portion of the launchpad 800 for at least a threshold period of time. In response, the control subsystem 102 may provide instructions to an administrator of the terminal 202, 206, 216 to inspect the particular portion of the launchpad 800 (e.g., the area where the obstruction 808 is detected). If a response is received (e.g., from the administrator of the terminal 202, 206, 216) that indicates that the portion of the launchpad 800 has become free of the particular obstruction 808 or never contained the obstruction 808, the control subsystem 102 may determine that the launchpad 800 is clear for departure of the autonomous vehicle 502. In some embodiments, the control subsystem 102 may flag any sensors, such as sensors 802f and/or 804b-d which may be associated with detecting the obstruction 808, in order to indicate that some review or maintenance of these sensors 802f and/or 804b-d is appropriate (e.g., if the detected obstruction 808 was found to have not been present in the launchpad 800).

If an obstruction 806, 808 is not detected within the zone of the launchpad 800 and an obstruction 810, 812 is not detected in front of the autonomous vehicle 502, the control subsystem 102 determines that the autonomous vehicle 502 is free to begin moving from the launchpad 800 at step 908, and the control subsystem 102 may proceed to step 914. At step 914, the control subsystem 102 determines whether no obstruction 806, 808, 810, 812 is detected for at least a predefined period of time (e.g., of at least one minute or more). If the launchpad 800 is determined to be free of obstructions 806, 808, 810, 812 for at least the predefined period of time, the control subsystem 102 proceeds to step 916. Otherwise, if the launchpad 800 is not determined to be free of obstructions 806, 808, 810, 812 for at least the predefined period of time, the control subsystem 102 continues to receive autonomous vehicle signals 832 and launchpad signals 830 to determine if the launchpad 502 remains free of obstructions 806, 808, 810, 812 for at least the predefined period of time.

At step 916, the control subsystem 102 may determine an appropriate outbound lane 318a-c along which the autonomous vehicle 502 should travel to begin movement along the route 204, 214 (e.g., to travel from the terminal 202, 206, 216 to a road). A lane 318a-c may initially be determined to provide a preferred starting point along the route 204, 214 and/or based on local traffic in the terminal 202, 206, 216. For example, a first lane 318a may be selected because lane 318a leads to a preferred road for starting movement along the route 204, 214 and/or is experiencing less traffic within the terminal 202, 206, 216. However, if an obstruction 812 is detected in the first outbound lane 318a, as illustrated in FIG. 8, the control subsystem 102 may determine an alternative outbound lane 318b or 318c on which the autonomous vehicle 502 should travel. For example, the control subsystem 102 may instruct the autonomous vehicle 502 to travel alone outbound lane 318c rather than 318b because lane 318c leads to a preferred starting point for the route 204, 214 or because lane 318c is known to have less traffic within the terminal 202, 206, 216. The autonomous vehicle 502 may also or alternatively determine and initiate its own lane adjustments as needed to facilitate safe autonomous driving from the launchpad 800 to a road on which to begin moving along the route 204, 214. At step 918, the control subsystem 102 provides instructions 118 with permission 816 to begin driving autonomously. Autonomous driving of the autonomous vehicle 502 is described in greater detail above with respect to FIGS. 5-7.

### Example Landing Pad and Landing Pad Operation

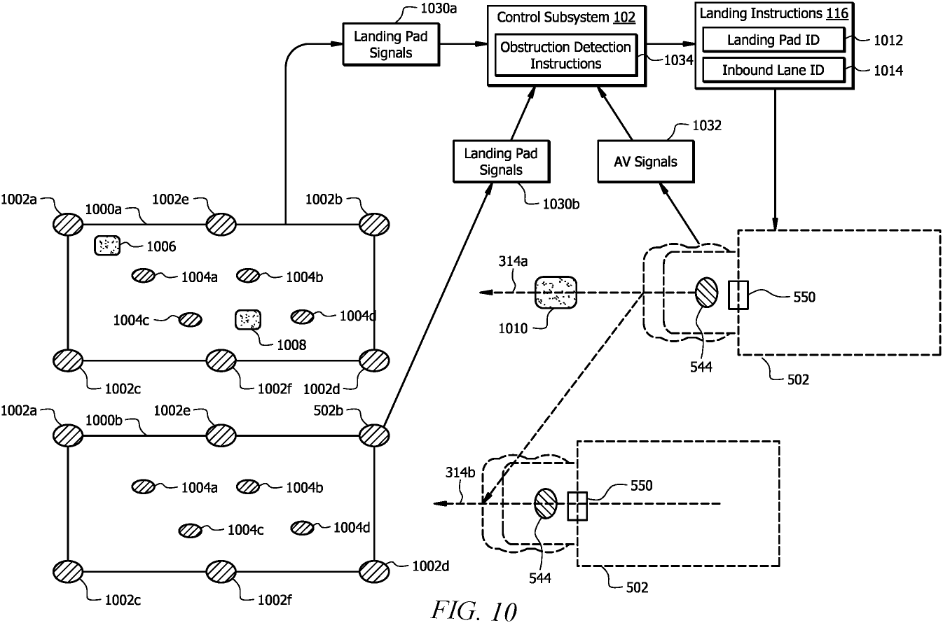

FIG. 10 illustrates example landing pad 1000a,b corresponding to a landing pad 310 of FIG. 3 in greater detail. The example landing pads 1000a,b illustrated in FIG. 10 include a predefined zone or space (e.g., within the terminal 202, 206, 216202, 206, 216 shown in FIG. 3) that is sized and shaped to accommodate an autonomous vehicle 502 and a set of sensors 1002a-f around the perimeter of or within the landing pad 1000a,b. As an example, the physical extent of each landing pad 1000a,b may be defined at least in part by the corresponding sensors 1002a-f located around or within the landing pad 1000a,b. Sensors 1002a-f are examples of sensors 312 of FIG. 3. In some embodiments, the landing pads 1000a,b include a physical pad (e.g., a concrete pad). In some embodiments, the landing pads 1000a,b includes physical markers (e.g., painted lines) or position markers 130 around one or more edges or the perimeter of the landing pads 1000a,b. The landing pads 1000a,b generally facilitate the safe and efficient receipt of inbound autonomous vehicles 502. In addition to facilitating the identification of a landing pad 1000a,b that is free of obstructions for the receipt of an inbound autonomous vehicle 502, the landing pads 1000a,b also facilitate the routing of inbound autonomous vehicles to areas within the terminal 202, 206, 216 that is appropriate for a cargo type being carried by the autonomous vehicle 502 or the carrier operating the autonomous vehicle 502. The landing pads 1000a,b may further facilitate improved record keeping of inbound shipments and the locations of these shipments within the terminal 202, 206, 216.

The sensors 1002a-f of the landing pads 1000a,b may be the same as or similar to the sensors 802a-f described above for the example launchpad 800 of FIG. 8. For example, the sensors 1002a-f may include any sensors capable of detecting objects, motion, sound, and the like, which may be used for the determination of the presence of obstructions 1006, 1008 within the zones of the landing pads 1000a,b. For example, the sensors 1002a-f may include cameras, LiDAR sensors, motion sensors, infrared sensors, and the like. Moreover, each sensor 1002a-f illustrated in FIG. 10 may correspond to one or more sensors positioned at various heights relative to the ground, for example, to provide views of different portions of the space above the ground within the zones of the landing pads 1000a,b, as described above with respect to the sensors 802a-f of FIG. 8. In some embodiments, landing pads 1000a,b may include one or more additional sensors 1004a-d on or within the surface of the landing pads 1000a,b. Sensors 1004a-d are other examples of sensors 312 of FIG. 3. These optional sensors 1004a-d may be the same as or similar to the sensors 804a-d described above with respect to FIG. 8. While the example of FIG. 10 shows six sensors 1002a-f and four sensors 1004a-d, it should be understood that a landing pad 1000a,b may include any appropriate number, combination, and placement of sensors (i.e., more or less than the number of sensors 1002a-f or 1004a-d illustrated in FIG. 10).

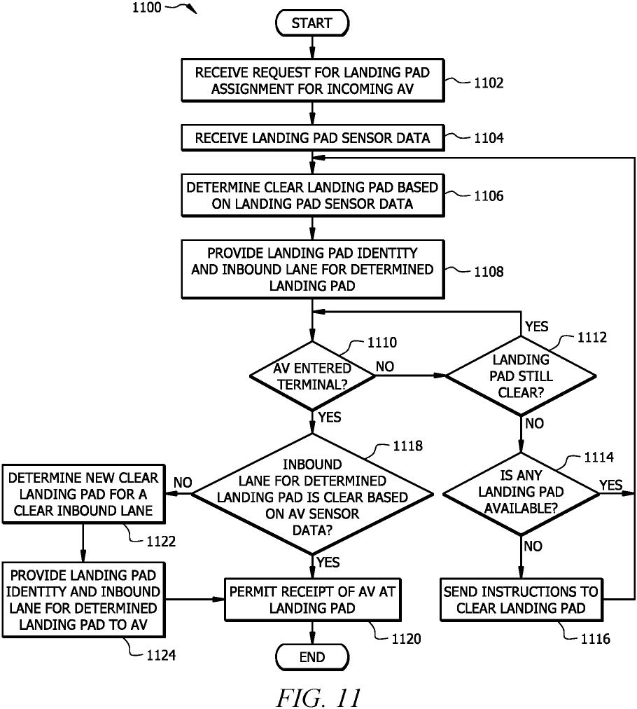

The sensors 1002a-f and 1004a-d of the landing pads 1000a,b are in signal communication with the control subsystem 102. As described further with respect to the example operation below and the method 1100 of FIG. 11, the sensors 1002a-f and 1004a-d generally communicate signals 1030,b (i.e., signals 1030a for the first landing pad 1000a and signals 1030b for the second landing pad 1000b) to the control subsystem 102. When an autonomous vehicle 502 is traveling to the terminal 202, 206, 216, the autonomous vehicle 502 may communicate to the control subsystem 102 that a landing pad 1000 will soon be needed to receive the autonomous vehicle 502. For example, the autonomous vehicle 502 may request a landing pad assignment when the autonomous vehicle 502 gets within a threshold distance of the terminal 202, 206, 216 (e.g., within ten miles of the terminal 202, 206, 216). In response to such a request for an assigned landing pad 1000, the control subsystem 102 determines, based on received landing pad signals 1030a,b (i.e., sensor data included in the signals 1030a,b), a landing pad 1000a,b that is free of obstructions 1006, 1008 that would prevent receipt of the autonomous vehicle 502. As an example, if a sensor 1002a-f or 1004a-d of the landing pad 1000a,b is a camera, the signal 1030a may include a video of a portion of the landing pad 1000a or 1000b viewed by the sensor 1002a-f or 1004a-d (i.e., the portion of the landing pad 1000a or 1000b within the field-of-view of the camera). The control subsystem 102 uses obstruction detection instructions 1034 to determine if an obstruction is detected in the video, similarly to as described above with respect to the example launchpad 310 of FIG. 3. The obstruction detection instructions 1034 may similarly include code for implementing approaches to detecting obstructions based on LiDAR data (e.g., based on the detection of an unexpected object in or around the landing pad 1000), motion sensor data (e.g., based on the detection of unexpected motion in or around the landing pad 1000), sound (e.g., the detection of an unexpected sound near the landing pad 1000), infrared data (e.g., based on the detection of an unexpected object in an infrared image), and the like.

If it is determined, as in the example of FIG. 10, that the first landing pad 1000a is not free of obstructions 1006, 1008 and the second landing pad 1000b is free of obstructions, the control subsystem 102 provides landing instructions 116 to the autonomous vehicle 502 that include an indication of the identity 1012 of the second landing pad 1000b. The instructions 116 may further include an identity 1014 of an appropriate inbound lane 314 which the autonomous vehicle 502 should travel along to reach the assigned landing pad 1000b. If the autonomous vehicle 502 detects an obstruction 1010 when traveling to the assigned landing pad 1000a,b, then the autonomous vehicle 502 may move into a different inbound lane 314a,b. In the example illustrated in FIG. 10, the autonomous vehicle 502 detects an obstruction 1010 in inbound lane 314a and moves into inbound lane 314b. The autonomous vehicle 502 may communicate with the control subsystem 102 to ensure that the alternative inbound lane 314b leads to the assigned landing pad 1000b, and if the alternative inbound lane 314b does not lead to the assigned landing pad 1000b, the control subsystem 102 may identify a different landing pad 1000a,b for the autonomous vehicle 502.

In an example operation of the landing pads 1000 of FIG. 10, the control subsystem 102 receives a request for a landing pad assignment for an inbound autonomous vehicle 502 which is scheduled to arrive at the terminal 202, 206, 216 soon (e.g., within the next fifteen minutes or so). Following receipt of this request, the control subsystem 102 receives landing pad sensor signals 1030a,b. The control subsystem 102 uses the landing pad sensor signals 1030a,b to identify a landing pad 1000a,b that is free of obstructions 1006, 1008. For example, if the sensors 1002a-f and/or 1004a-d include cameras, the landing pad sensor signals 1030a,b may include images or video. In such cases, the control subsystem 102 may employ obstruction detection instructions 1034 which include rules for detecting objects in the image or video and determining whether the detected objects correspond to obstructions 1006, 1008. For example, one or more predetermined methods of object detection (e.g., employing a neural network or method of machine learning) may be used to detect objects and determine whether a detected object corresponds to an obstruction 1006, 1008. Signals from infrared sensors 1002a-f and/or 1004a-d may be similarly evaluated to detect portions of infrared images with heat signatures associated with the presence of animals and/or people within the zone of the landing pads 1000a,b.

As another example, if the sensors 1002a-f or 1004a-d include LiDAR sensors, the landing pad sensor signals 1030a,b may include distance measurements. In such cases, the control subsystem 102 may employ obstruction detection instructions 1034 which include rules for detecting obstructions 1006, 1008 based on characteristics and/or changes in the distance measurements. For example, changes in distances measured by a LiDAR sensor may indicate the presence of an obstruction 1006, 1008. For example, each LiDAR sensor may be calibrated to provide an initial distance measurement for when the landing pad 1000a,b is known to be free of obstructions 1006, 1008. If the distance reported by a given LiDAR sensor changes from this initial value, an obstruction 1006, 1008 may be detected.

As yet another example, if the sensors 1002a-f and/or 1004a-d include motion sensors, the landing pad signals 1030a,b may include motion data for the landing pads 1000a,b. In such cases, the control subsystem 102 may employ obstruction detection instructions 1034 which include rules for detecting obstructions 1006, 1008 based on detected movement. For example, movement or motion detected within the zone of a landing pad 1000a,b may be caused by the presence of an animal or person within the zone of the landing pad 1000a,b. Thus, if motion is detected within the zone of a landing pad 1000a,b, then the control subsystem 102 may determine that an obstruction 1006, 1008 is detected within the zone of the landing pad 1000a,b. In some cases, before an obstruction 1006, 1008 is detected based on motion, detected movement may need to persist for at least a threshold period of time (e.g., fifteen seconds or more) to reduce or eliminate the false positive detection of obstructions 1006, 1008 caused by wind and/or other transient events (e.g., an animal, person, or vehicle passing through and immediately leaving the zone of a landing pad 1000a,b).

As a further example, if the sensors 1002a-f and/or 1004a-d include microphones for recording sounds in or around the landing pads 1000a,b, the landing pad signals 1030a,b may include such sound recordings. In such cases, the control subsystem 102 may employ obstruction detection instructions 1034 which include rules for detecting obstructions 1006, 1008 based on characteristics of the recorded sounds. For example, a sound corresponding to a person speaking, a vehicle operating or undergoing maintenance, or an animal making a characteristic sound may be evidence that an obstruction 1006, 1008 is within the zone of the landing pad 1000a,b. While certain examples of the detection of obstructions 1006, 1008 are described above, it should be understood that any other appropriate method of obstruction detection may be used by the control subsystem 102. For example, obstructions 1006, 1008 may be detected using the methods and/or modules described for the detection of objects and obstacles by the autonomous vehicle 502 (see FIG. 6 and corresponding description above).

If an appropriate landing pad 1000a,b is not detected, the control subsystem 102 may instruct an individual at the terminal 202, 206, 216 to clear obstructions from an appropriate landing pad 1000a,b, and this landing pad 1000a,b may subsequently be assigned to the inbound autonomous vehicle 502 (e.g., after the control subsystem 102 verifies that the landing pad 1000a,b is now free of obstructions). In addition to assigning a landing pad 1000a,b to which the autonomous vehicle 502 should navigate and come to a stop, the control subsystem 102 may also provide an identifier 1014 of an appropriate inbound lane 314a,b for traveling through the terminal 202, 206, 216 to safely reach the assigned landing pad 1000a,b.

When the autonomous vehicle 502 enters the terminal 202, 206, 216 and begins traveling along its assigned lane 314a,b, the autonomous vehicle 502 may detect an obstruction 1010 in its path. In response, the autonomous vehicle 502 may request that a new inbound lane 314a,b be assigned to the autonomous vehicle 502 in order to reach the assigned landing pad 1000a,b. Alternatively, the autonomous vehicle 502 may automatically move into a different inbound lane 314a,b (e.g., into the free inbound lane 314b as illustrated in the example of FIG. 10) and travel along this new lane 314a,b. The autonomous vehicle 502 may communicate with the control subsystem 102 to verify that the new inbound lane 314a,b can be used to reach the assigned landing pad 1000a,b. If the new inbound lane 314a,b does not reach the assigned landing pad 1000a,b, the control subsystem 102 may determine a new landing pad 1000a,b to assign to the autonomous vehicle 502 (i.e., a landing pad 1000a,b which may be reached from the new lane 314a,b) or assign a new lane to the autonomous vehicle 502 (i.e., such that the autonomous vehicle 502 may navigate to the new assigned lane 314a,b to reach the appropriate assigned landing pad 1000a,b).

FIG. 11 illustrates an example method 1100 of using the landing pads 1000a,b of FIG. 10. The method 1100 may be implemented by the landing pads 1000a,b, autonomous vehicles 502, and control subsystem 102. The method 1100 may begin at step 1102 where the control subsystem 102 receives a request for assignment of a landing pad 1000a,b that can receive an inbound autonomous vehicle 502. The request may include an expected arrival time of the autonomous vehicle 502 and other information about the autonomous vehicle 502, such as the size of the autonomous vehicle 502 (i.e., such that the assigned landing pad 1000a,b is an appropriate size), a type of cargo transported by the autonomous vehicle 502 (e.g., such that the autonomous vehicle 502 is directed to a landing pad 1000a,b that is appropriate for receiving such cargo).

At step 1104, the control subsystem 102 receives landing pad signals 1030a,b. As described above, the landing pad signals 1030a,b generally include data from the landing pad sensors 1002a-f or 1004a-d. The landing pad signals 1030a,b may include one or more streams of image data, video data, distance measurement data (e.g., from LiDAR sensors), motion data, infrared data, and the like.

At step 1106, the control subsystem 102 determines a landing pad 1000a,b that is free of obstructions 1006, 1008 that would prevent receipt of the incoming autonomous vehicle 502. For example, the control subsystem 102 may determine, based on the landing pad signals 1030a,b, if an obstruction 1006, 1008 is detected within the zones of the landing pads 1000a,b. For example, the control subsystem 102 may use the obstruction detection instructions 1034 to determine if an obstruction 1006, 1008 is detected based on an image, a video, motion data, LiDAR data, an infrared image, and/or a sound recording included in the landing pad signals 1030a,b. Examples of the detection of obstructions 1006, 1008 in the zones of the landing pads 1000a,b are described above with respect to FIG. 10. In some embodiments, the control subsystem 102 further determines an inbound lane 314a,b that the incoming autonomous vehicle 502 should travel along to reach the landing pad 1000a,b that is determined to be free of obstructions 1006, 1008. For example, the lane 314a,b may be selected based on its proximity to a road from which the autonomous vehicle 502 is expected to enter the terminal 202, 206, 216, known traffic within the terminal 202, 206, 216, and/or the cargo type transported by the incoming autonomous vehicle 502. In some embodiments, the control subsystem 102 may first determine that landing pad 1000a,b is free of obstructions 1006, 1008 for at least a threshold time period (e.g., of 15 minutes or any other appropriate period of time) before proceeding to step 1108.

At step 1108, the control subsystem 102 provides landing instructions 116 to the incoming autonomous vehicle 502. As described above, the landing instructions 116 may include an indication of the identity 1012 of the landing pad 1000a,b that was identified at step 1106. The instructions 116 may further include an identity 1014 of an appropriate inbound lane 314a,b which the autonomous vehicle 502 should travel along to reach the assigned landing pad 1000a,b.

At step 1110, the control subsystem 102 determines whether the autonomous vehicle 502 has entered the terminal 202, 206, 216. If the autonomous vehicle has not entered the terminal 202, 206, 216 yet, the control subsystem 102 may proceed to step 1112 to check that the assigned landing pad 1000a,b remains free of obstructions 1006, 1008. For example, the control subsystem may determine whether an obstruction 1006, 1008 is detected as described above with respect to step 1106. If an obstruction is detected at step 1112, the control subsystem 102 may proceed to step 1114 to check whether there are any available landing pads 1000a,b.

If no landing pad 1000a,b is available at step 1114, the control subsystem 102 may proceed to step 1116 where the control subsystem 102 sends an instruction to clear a landing pad 1000a,b to receive the inbound autonomous vehicle 502. For example, the control subsystem 102 may detect a particular obstruction 1006,1008 in a particular portion of the landing pad 1000a,b for at least a threshold period of time. In response, the control subsystem 102 may provide instructions to an administrator of the terminal 202, 206, 216 to inspect the particular portion of the landing pad 1000a,b (e.g., the area where the obstruction 1006, 1008 is detected). If a response is received (e.g., from the administrator of the terminal 202, 206, 216) by the control subsystem 102 that indicates that the portion of the landing pad 1000a,b has become free of the particular obstruction 1006, 1008, the control subsystem 102 may determine that the landing pad 1000a,b is available for receipt of the incoming autonomous vehicle 502. In some embodiments, the control subsystem 102 may flag any sensors, such as sensors 1002a-f and/or 1004a-d which may be associated with detecting the obstruction 1006, 1008, in order to indicate that some review or maintenance of these sensors 1002a-f and/or 1004a-d may be appropriate (e.g., if a detected obstruction 1006, 1008 was not actually present in the zone of the landing pad 1000a,b such that the sensor 1002a-f and/or 1004a-d was likely malfunctioning). The control subsystem 102 generally then returns to step 1106 described above to identify a landing pad 1000a,b to assign to the incoming autonomous vehicle 502.

If the control subsystem determines, at step 1110, that the autonomous vehicle 502 has entered the terminal 202, 206, 216, the control subsystem 102 may continue to monitor signals 1032 received from the autonomous vehicle 502 in case a different landing pad 1000a,b and/or inbound lane 314a,b should for some reason be assigned to the autonomous vehicle 502, as exemplified by example steps 1118, 1120, 1122, 1124. At step 1118, the control subsystem 102 determines that the inbound lane 314a,b assigned to the autonomous vehicle 502 is blocked by an obstruction 1010. For example, the autonomous vehicle 502 may detect the obstruction 1010 using the vehicle sensor subsystem 544 and in-vehicle computer 550 and communicate the detected obstruction 1010 to the control subsystem 102. If such a communication is received, the control subsystem 102 may determine a new landing pad 1000a,b at step 1122 (e.g., as escribed above with respect to step 1106) and provide new landing instructions 116 to the autonomous vehicle 502 at step 1124 before permitting the autonomous vehicle 502 to stop at the assigned landing pad 1000a,b at step 1120. For example, at step 1118, the control subsystem 102 may receive an indication that the autonomous vehicle 502 has detected obstruction 1010 and moved from initial inbound lane 314a to alternate new inbound lane 314b. The control subsystem 102 may check that the alternate lane 314b leads to the assigned landing pad 1000a,b. If the alternate lane 314b does not lead to the assigned landing pad 1000a,b, the control subsystem 102 may determine a new landing pad 1000a,b that can be accessed from the alternate lane 314b or determine a different inbound lane 314a,b that can be used to reach the assigned landing pad 1000a,b.

### Example Relaunching of Autonomous Vehicle Following Out-of-Terminal Maintenance

FIG. 12A illustrates an example of a mobile autonomous vehicle re-launching system 1200 that may be included in the mobile terminal system 100 to aid in relaunching autonomous vehicles 502 following out-of-terminal maintenance. The re-launching system 1200 includes the portable device 1202 (see e.g., the portable device 126 of FIG. 1), the control subsystem 102, and an autonomous vehicle 502. The re-launching system 1200 generally facilitates the restarting of movement of the autonomous vehicle 502 along its route 204, 214 following a stop. For example, if the autonomous vehicle 502 stops for maintenance or any other reason, one or more users 1204 at the location of the stopped autonomous vehicle 502 may operate the portable device 1202 to confirm that at least a first portion 1206 of the zone or space around the autonomous vehicle 502 is free of obstructions 1216a,b that would prevent safe movement of the autonomous vehicle 502. In one embodiment, a user 1204 comprises a mechanic, repairman, service technician, monitor, emergency personnel, or other appropriate individual that facilitates re-launching autonomous vehicle 502 after it has stopped, such as for example, along route 204, 214. The vehicle sensor subsystem 544 and/or in-vehicle control computer 550 of the autonomous vehicle 502 may provide information 1222 which includes autonomous vehicle sensor data and/or another confirmation indicating whether at least a second portion 1208 of the zone around the stopped autonomous vehicle 502 is free of obstructions 1216c. If control subsystem 102 determines that both portion 1206 and portion 1208 of the zone around the stopped autonomous vehicle 502 are free of obstructions 1216a-c, the control subsystem 102 may provide permission 1224 for the stopped autonomous vehicle 502 to begin moving again (e.g., by moving back into the road 1226 to travel along the route 204, 214 of FIG. 2).

The device 1202 may be any mobile or portable device (e.g., a mobile phone, computer, or the like). The portable device 1202 generally includes a user interface which is operable to receive user input. The user input may include a confirmation 1218 that is provided by the user 1204 after the user 1204 verifies that the portion 1206 of the zone around the autonomous vehicle 502 is free of obstructions 1216a,b. The portable device 1202 may include a camera or other appropriate sensor for obtaining images and/or videos 1220 which may be provided to the control subsystem 102. As described further below and with respect to FIG. 13, the control subsystem 102 (or the portable device itself) may determine whether an obstruction 1216a,b is detected in the images and/or videos 1218 (e.g., using the obstruction detection instructions 836, 1034 described above with respect to FIGS. 8-11). Example components of a portable device 1202 are illustrated in FIG. 12B and described further below.

In some embodiments, the user 1204 visually inspects the portion 1206 of the zone around the autonomous vehicle 502 to determine if an obstruction 1216a,b is present. If no obstruction 1216a,b is detected by the user 1204, the user 1204 may input confirmation 1218 that the zone portion 1206 is free of obstructions 1216a,b, and the portable device 1202 may send the confirmation 1218 to the control subsystem 102. In embodiments in which the portable device 1202 includes a camera, the user 1204 may move the portable device 1202 around the zone portion 1206 to obtain images and/or video of the zone portion 1206. For example, images and/or videos 1220 may be obtained for various fields-of-view 1212a-f such that the images and/or video 1220 encompass at least the zone portion 1206. For example, the user 1204 may move around the vehicle and capture images and/or videos 1220 at the positions 1210a-f illustrated by an “X” in FIG. 12A, such that the camera of the portable device 1202 (e.g., camera 1258 of the example portable device 1202 illustrated in FIG. 12B) captures images and/or video 1220 for the different fields-of-view 1212a-f. In a particular embodiment, the user 1204 moves around the vehicle and captures images and/or videos 1220 at the positions 1210a-f within a predetermined time period determined to be short enough that a determination can be made whether the zone portion 1206 is clear and safe to re-launch autonomous vehicle 502.

In some embodiments, part of the autonomous vehicle 502 (e.g., the trailer attached to the autonomous vehicle 502) may include visible markers 1214a-f which are positioned to facilitate the user-friendly capture of images and/or videos 1220 that encompass at least the zone portion 1206. The user 1204 may position the portable device 1202 such that images and/or videos 1220 are taken that capture each of the markers 1214a-f. The markers 1214a-f may include a barcode which can be interpreted by the control subsystem 102 in received images and/or video 1220. Thus, the markers 1214a-f may ensure that the images and/or video 1220 provided from the portable device 1202 include views that are appropriate for ensuring that the portion 1206 of the zone around the autonomous vehicle 502 is free of obstructions 1216a,b. The markers 1214a-f may further be used to identify the autonomous vehicle 502 that is being re-launched by the re-launching system 1200, such that the control subsystem 102 may efficiently identify the stopped autonomous vehicle 502 and maintain a record of its re-launch.

In embodiments involving the provision of images and/or videos 1220 from the portable device 1202, the control subsystem 102 receives the images and/or videos 1220 and uses the obstruction detection instructions 1230 to determine if an obstruction 1216a,b is detected in the images and/or videos 1220. Examples of the detection of obstructions such as obstructions 1216a,b is described above with respect to FIGS. 8-11, and the same or similar approaches may be used to detect obstructions 1216a,b. For example, the control subsystem 102 may use the obstruction detection instructions 1230 which include rules for detecting objects in the images and/or videos 1220 and determining whether the detected objects correspond to obstructions 1216a,b. For example, one or more predetermined methods of object detection (e.g., employing a neural network or method of machine learning) may be used to detect objects and determine whether a detected object corresponds to an obstruction 1216a,b.

The control subsystem 102 also receives information 1222 from the autonomous vehicle 502 which includes sensor data and/or an indication of whether an obstruction 1216c is detected in the portion 1208 of the zone around the autonomous vehicle 502 (see FIG. 6 and corresponding description above regarding the detection of obstacles or obstructions by the autonomous vehicle 502). The portion 1208 of the zone around the autonomous vehicle 502 generally includes a region in front of the autonomous vehicle 502 (e.g., in the field-of-view of one or more sensors of the vehicle sensor subsystem 544 of the autonomous vehicle 502). In some cases, the in-vehicle control computer 550 may determine whether an obstruction 1216c is detected in the zone portion 1208 and provide this information 1222 to the control subsystem 102. In other cases, the autonomous vehicle 502 may provide the information 1222 as data from the vehicle sensor subsystem 544 of the autonomous vehicle 502. In such cases, the control subsystem 102 may use the obstruction detection instructions 1230 to determine if an obstruction 1216c is detected in the zone portion 1208, as described above with respect to the detection of obstructions 1216a,b and with respect to FIGS. 8-11.

In an example operation of the mobile autonomous vehicle re-launching system 1200, the autonomous vehicle 502 comes to a stop at the side of the road 1226 for maintenance (e.g., to repair or replace a flat tire or the like). A service technician (e.g., user 1204) arrives at the location of the stopped autonomous vehicle 502 and performs the needed maintenance. Following completion of the maintenance, the autonomous vehicle 502 may be ready to return to the road 1226 and continue moving along the route 204, 214. However, the autonomous vehicle 502 alone may not be capable of ensuring that there are no obstructions along the sides and rear of the autonomous vehicle 502. For instance, the vehicle sensor subsystem 544 may not provide a view that encompasses the portion 1206 of the space around the autonomous vehicle 502 where the example obstruction 1216a is located near the side of the trailer of the autonomous vehicle 502 and the obstruction 1216b is under the trailer attached to the autonomous vehicle 502. In order to ensure that the autonomous vehicle 502 returns safely to the road 1226, the service technician (user 1204) may operate the portable device 1202 to aid in re-launching the stopped autonomous vehicle 502 along its route 204, 214.

In some cases, the service technician (user 1204) may visibly inspect at least the portion 1206 of the zone around the stopped autonomous vehicle 502 to determine whether the autonomous vehicle 502 is free of obstructions 1216a,b that would prevent safe movement of the autonomous vehicle 502. If the service technician (user 1204) determines that at least the portion 1206 of the zone around the autonomous vehicle 502 is free of obstructions 1216a,b, then the service technician (user 1204) may operate the device 1202 to provide a confirmation that the zone portion 1206 is free of obstructions 1216a,b to the control subsystem 102. Upon receiving the confirmation 1218, the control subsystem 102 uses information 1222 provided by the autonomous vehicle 502 to determine if the portion 1208 of the zone around the stopped autonomous vehicle 502 is also free of obstructions 1214c. If both of the zones 1206, 1208 are free of obstructions 1216a-c, then the control subsystem 102 provides permission 1224 for the autonomous vehicle 502 to begin moving to the road 1226. Otherwise, if either of zones 1206 or 1208 is not free of obstructions 1216a-c, then permission 1224 is not provided.

In other cases, rather than using the confirmation 1218 alone, the service technician (user 1204) may also or alternatively capture images and/or video 1220 of the zone portion 1206 using portable device 1202. These images and/or video 1220 may be provided to the control subsystem 102 in order to determine if the portion 1206 of the zone around the stopped autonomous vehicle 502 is free of obstructions 1216a,b. For instance, in an example case where images 1220 are provided to the control subsystem 102, the service technician (user 1204) may move about the autonomous vehicle 502 and capture images 1220 of the autonomous vehicle 502 and areas around the autonomous vehicle 502 from different perspectives (e.g., at different positions 1210a-f illustrated in FIG. 12A). In some embodiments, the service technician (user 1204) may use the device 1202 to capture images 1220 that include the markers 1214a-f such that images 1220 include representations of obstructions 1216a,b that may be present in the fields-of-view 1212a-f. As another example, in a case where video 1220 is provided to the control subsystem 102, the service technician (user 1204) may move about the autonomous vehicle 502 to capture video 1220 of the autonomous vehicle 502 and areas around the autonomous vehicle 502 from different perspectives (e.g., a video 1220 captured as the service technician moves between the different positions 1210a-f illustrated in FIG. 12A). The control subsystem 102 uses the obstruction detection instructions 1230 to detect any obstructions 1216a,b appearing in the images and/or videos 1220.

Following a determination that no obstruction 1216a,b is detected in the images and/or videos 1220, the control subsystem 102 uses information 1222 provided by the autonomous vehicle 502 to determine if the portion 1208 of the zone around the stopped autonomous vehicle 502 is also free of obstructions 1214c, as described above. If both of the zones 1206, 1208 are free of obstructions 1216a-c, then the portable device 1202 provides permission 1224 for the autonomous vehicle 502 to begin moving to the road 1226. Otherwise, if either of zones 1206 or 1208 is not free of all obstructions 1216a-c, then permission 1224 is not provided.

FIG. 12B shows an embodiment of a portable device 1202 of FIG. 12A. The portable device 1202 includes a processor 1252, a memory 1254, a network interface 1256, and a camera 1258. The portable device 1202 may be configured as shown or in any other suitable configuration.

The processor 1252 includes one or more processors operably coupled to the memory 1254. The processor 1252 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 1252 may be a programmable logic device, a microcontroller, a microprocessor, or any suitable combination of the preceding. The processor 1252 is communicatively coupled to and in signal communication with the memory 1254 and the network interface 1256. The one or more processors are configured to process data and may be implemented in hardware or software. For example, the processor 1252 may be 8-bit, 16-bit, 32-bit, 64-bit or of any other suitable architecture. The processor 1252 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions to implement the function disclosed herein, such as some or all of those described with respect to FIGS. 12A and 13. In some embodiments, the function described herein is implemented using logic units, FPGAs, ASICs, DSPs, or any other suitable hardware or electronic circuitry.

The memory 1254 is operable to store any of the information described above with respect to FIG. 12A along with any other data, instructions, logic, rules, or code operable to implement the function(s) described herein when executed by processor 1252. The memory 1254 includes one or more disks, tape drives, or solid-state drives, and may be used as an over-flow data storage device, to store programs when such programs are selected for execution, and to store instructions and data that are read during program execution. The memory 1254 may be volatile or non-volatile and may comprise read-only memory (ROM), random-access memory (RAM), ternary content-addressable memory (TCAM), dynamic random-access memory (DRAM), and static random-access memory (SRAM).

The network interface 1256 is configured to enable wired and/or wireless communications. The network interface 1256 is configured to communicate data between the portable device 1202 and other network devices, systems, or domain(s). For example, the network interface 1256 may comprise a WIFI interface, a local area network (LAN) interface, a wide area network (WAN) interface, a modem, a switch, or a router. The processor 1252 is configured to send and receive data using the network interface 1256. The network interface 1256 may be configured to use any suitable type of communication protocol.

The camera 1258 is configured to obtain an image and/or video 1258. Generally, the camera 1258 may be any type of camera. For example, the camera 1258 may include one or more sensors, an aperture, one or more lenses, and a shutter. The camera 1258 is in communication with the processor 1252, which controls operations of the camera 1258 (e.g., opening/closing of the shutter, etc.). Data from the sensor(s) of the camera 1258 may be provided to the processor 1252 and stored in the memory 1254 in an appropriate image or video format for use by control subsystem 102.

FIG. 13 illustrates an example method 1300 of operating the mobile autonomous vehicle re-launching system 1200 of FIG. 12A. The method 1300 may be implemented by the portable device 1202, control subsystem 102, and/or autonomous vehicle 502. The method 1300 may begin at step 1302 where the control subsystem 102 receives a request to re-launch the autonomous vehicle 502. For example, a user 1204 (e.g., a service technician, as described with respect to the example of FIG. 12A above) may provide an indication that maintenance and any appropriate testing of the stopped autonomous vehicle 502 is complete.

At step 1304, the control subsystem 102 receives confirmation 1218 that the zone portion 1206 is free of obstructions and/or receives images and/or video 1220 of the zone portion 1206, as described above with respect to FIG. 12A. In some embodiments, receipt of the confirmation 1218 and/or the images and/or video 1220 acts as a request to permit re-launch of the autonomous vehicle 502 (i.e., such that a separate request is not received at step 1302).

At step 1306, the control subsystem 102 receives information 1222 from the autonomous vehicle 502. The information 1222 may include a confirmation that the in-vehicle computer 550 has not detected an obstruction 1216c in the zone portion 1208 and/or sensor data from the vehicle sensor subsystem 544.

At step 1308, the control subsystem 102 determines if the zone around the autonomous vehicle 502 is free of obstructions 1216a-c preventing safe movement of the autonomous vehicle 502. For example, as described above with respect to FIG. 12A, if it is determined that both zone portion 1206 and zone portion 1208 around the stopped autonomous vehicle 502 are free of obstructions 1216a-c, the control subsystem 102 determines that the zone around the autonomous vehicle 502 is clear for movement of the autonomous vehicle 502. Otherwise, if the control subsystem 102 determines that at least one of the zone portions 1206 or 1208 around the stopped autonomous vehicle 502 is not free of obstructions 1216a-c, the control subsystem 102 determines that the zone around the autonomous vehicle 502 is not clear for movement of the autonomous vehicle 502.

If the zones 1206, 1208 around the stopped autonomous vehicle 502 are determined to be clear for safe movement of the stopped autonomous vehicle 502, the control subsystem 102 proceeds to step 1310 where the control subsystem 102 provides permission 1224 for the autonomous vehicle 502 to begin moving. Otherwise, if the zones 1206, 1208 around the stopped autonomous vehicle 502 are determined to not be clear for safe movement of the stopped autonomous vehicle 502, the control subsystem 102 may prevent the stopped autonomous vehicle 502 from beginning to move. The control subsystem 102 may further proceed to step 1312 to determine if the stopped autonomous vehicle 502 has been prevented from moving for at least a threshold time. If this is the case, the control subsystem 102 may provide an alert at step 1314 for further action to be taken to clear the zone around the autonomous vehicle 502 (e.g., by removing one or more of the obstructions 1216a-c or requesting other action from the user 1204).

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.

Clause 1. A system comprising:
a fleet of autonomous vehicles, each autonomous vehicle of the fleet configured to move autonomously along a predetermined route;
a manually operated vehicle storing equipment configured to establish a short-term terminal site operable to support movements of the fleet of autonomous vehicles, wherein the equipment stored in the manually operated vehicle comprises one or more of secure data storage media, an autonomous vehicle repair kit, sensor repair and calibration tools, and a terminal site setup kit comprising position delineators configured to establish regions within a physical space as portions of a short-term terminal site; and
a control subsystem comprising a hardware processor configured to provide instructions to the fleet of autonomous vehicles, the instructions comprising a location of the short-term terminal site established using the terminal site setup kit.

Clause 2. The system of Clause 1, wherein the established short-term terminal site facilitates one or more of inspection of the autonomous vehicles, maintenance of the autonomous vehicles, calibration of sensors of the autonomous vehicles, cleaning of sensors of the autonomous vehicles, and unloading of items transported by the autonomous vehicles.

Clause 3. The system of Clause 1, wherein the hardware processor is further configured to:
receive an inspection report associated with an inspection of an autonomous vehicle of the fleet in the short-term terminal site; and
provide the inspection report sent to autonomous vehicle management system.

Clause 4. The system of Clause 1, wherein the hardware processor is further configured to determine that the short-term terminal site should be established to provide support for a proof-of-concept or temporary route.

Clause 5. The system of Clause 4, wherein the hardware processor is further configured to determine that the proof-of-concept or temporary route is needed after detecting at least one of an increase in transportation volume in a region of the short-term terminal site and a need for support of the fleet of autonomous vehicles within less than one week from a current time.

Clause 6. The system of Clause 1, wherein:
the vehicle further comprises a set of sensors comprising a global positioning system (GPS) transceiver operable to determine route data indicating geographic coordinates of a route for the fleet of autonomous vehicles to travel along to reach the short-term terminal site; and
the hardware processor is further configured to provide the geographic coordinates to at least one autonomous vehicle of the fleet of autonomous vehicles.

Clause 7. The system of Clause 1, wherein the hardware processor is further configured to receive a request for out-of-terminal maintenance at another location, wherein following receipt of the request, the manually operated vehicle is moved to the location with an autonomous vehicle repair kit.

Clause 8. A method comprising:
storing, in a manually operated vehicle, equipment configured to establish a short-term terminal site operable to support movements of a fleet of autonomous vehicles, wherein the equipment stored in the manually operated vehicle comprises one or more of secure data storage media, an autonomous vehicle repair kit, sensor repair and calibration tools, and a terminal site setup kit comprising position delineators configured to establish regions within a physical space as portions of a short-term terminal site; and
providing, via a control subsystem associated with the manually operated vehicle, instructions to the fleet of autonomous vehicles, the instructions comprising a location of the short-term terminal site established using the terminal site setup kit.

Clause 9. The method of Clause 8, wherein the established short-term terminal site facilitates one or more of inspection of the autonomous vehicles, maintenance of the autonomous vehicles, calibration of sensors of the autonomous vehicles, cleaning of sensors of the autonomous vehicles, and unloading of items transported by the autonomous vehicles.

Clause 10. The method of Clause 8, further comprising:
receiving an inspection report associated with an inspection of an autonomous vehicle of the fleet in the short-term terminal site; and
providing the inspection report sent to autonomous vehicle management system.

Clause 11. The method of Clause 8, further comprising determining that the short-term terminal site should be established to provide support for a proof-of-concept or temporary route.

Clause 12. The method of Clause 11, further comprising determining that the proof-of-concept or temporary route is needed after detecting at least one of an increase in transportation volume in a region of the short-term terminal site and a need for support of the fleet of autonomous vehicles within less than one week from a current time.

Clause 13. The method of Clause 8, further comprising:
determining route data indicating geographic coordinates of a route for the fleet of autonomous vehicles to travel along to reach the short-term terminal site; and
providing the geographic coordinates to at least one autonomous vehicle of the fleet of autonomous vehicles.

Clause 14. The method of Clause 8, further comprising receiving a request for out-of-terminal maintenance at another location, wherein following receipt of the request, the manually operated vehicle is moved to the location with an autonomous vehicle repair kit.

Clause 15. A system comprising:
a manually operated vehicle storing equipment configured to establish a short-term terminal site operable to support movements of a fleet of autonomous vehicles, wherein the equipment stored in the manually operated vehicle comprises one or more of secure data storage media, an autonomous vehicle repair kit, sensor repair and calibration tools, and a terminal site setup kit comprising position delineators configured to establish regions within a physical space as portions of a short-term terminal site; and
a control subsystem comprising a hardware processor configured to provide instructions to the fleet of autonomous vehicles, the instructions comprising a location of the short-term terminal site established using the terminal site setup kit.

Clause 16. The system of Clause 15, wherein the established short-term terminal site facilitates one or more of inspection of the autonomous vehicles, maintenance of the autonomous vehicles, calibration of sensors of the autonomous vehicles, cleaning of sensors of the autonomous vehicles, and unloading of items transported by the autonomous vehicles.

Clause 17. The system of Clause 15, wherein the hardware processor is further configured to:
receive an inspection report associated with an inspection of an autonomous vehicle of the fleet in the short-term terminal site; and
provide the inspection report sent to autonomous vehicle management system.

Clause 18. The system of Clause 15, wherein the hardware processor is further configured to determine that the short-term terminal site should be established to provide support for a proof-of-concept or temporary route.

Clause 19. The system of Clause 18, wherein the hardware processor is further configured to determine that the proof-of-concept or temporary route is needed after detecting at least one of an increase in transportation volume in a region of the short-term terminal site and a need for support of the fleet of autonomous vehicles within less than one week from a current time.

Clause 20. The system of Clause 15, wherein:
the vehicle further comprises a set of sensors comprising a global positioning system (GPS) transceiver operable to determine route data indicating geographic coordinates of a route for the fleet of autonomous vehicles to travel along to reach the short-term terminal site; and
the hardware processor is further configured to provide the geographic coordinates to at least one autonomous vehicle of the fleet of autonomous vehicles.

Clause 21. The system of Clause 15, wherein the hardware processor is further configured to receive a request for out-of-terminal maintenance at another location, wherein following receipt of the request, the manually operated vehicle is moved to the location with an autonomous vehicle repair kit.

Clause 22. A mobile terminal system to operate a fleet of autonomous vehicles, the mobile terminal system comprising:
position delineators configured when deployed to establish a terminal site within a physical space, wherein the established terminal site comprises at least one landing pad sized and shaped to accommodate an autonomous vehicle of the fleet; and
a control subsystem comprising a hardware processor configured to:
determine that an autonomous vehicle of the fleet is in-bound to the established terminal site;
after determining that the autonomous vehicle is in-bound to the established terminal site, determine landing instructions indicating a landing pad in which the in-bound autonomous vehicle is to stop and a route that the in-bound autonomous vehicle is to travel along to reach the landing pad; and
provide the landing instructions to the in-bound autonomous vehicle, wherein the landing instructions cause the in-bound autonomous vehicle to travel along the route to the landing pad.

Clause 23. The mobile terminal system of Clause 22, wherein:
the control subsystem further comprises a set of sensors comprising a global positioning system (GPS) transceiver operable to determine route data indicating an external route for the autonomous vehicles of the fleet to travel along to reach the established terminal site; and
the hardware processor is further configured to provide the route data to at least one autonomous vehicle of the fleet.

Clause 24. The mobile terminal system of Clause 23, wherein:
the hardware processor is further configured to receive instructions indicating that a new terminal site needs to be established;
the global positioning system is operable to determine new route data indicating a new route for the autonomous vehicles of the fleet to travel along to reach the new terminal site; and
the hardware processor is further configured to provide the new route data to the at least one autonomous vehicle of the fleet.

Clause 25. The mobile terminal system of Clause 22, wherein the hardware processor is further configured to determine that the in-bound autonomous vehicle is in-bound to the established terminal site by receiving a landing request from the in-bound autonomous vehicle, the landing request comprising a request for the in-bound autonomous vehicle to be granted permission to stop at the landing pad of the established terminal site.

Clause 26. The mobile terminal system of Clause 22, wherein the hardware processor is further configured to determine that the in-bound autonomous vehicle is on route to the established terminal site when one or both of the following are satisfied: (i) the in-bound autonomous vehicle is within threshold distance of the established terminal site and (ii) the in-bound autonomous vehicle is traveling along a known route to the established terminal site.

Clause 27. The mobile terminal system of Clause 22, wherein the landing instructions comprise at least one of a time during which the in-bound autonomous vehicle can enter the established terminal site, a route within the established terminal site that the in-bound autonomous vehicle is to travel along to reach the landing pad, a location of the landing pad within the established terminal site, and an identifier of the landing pad.

Clause 28. The mobile terminal system of Clause 23, wherein:
the system further comprises one or more movement sensors that are deployed within the established terminal site; and
the hardware processor is further configured to:
   receive movement data from the one or more movement sensors indicating an amount of traffic within the established terminal site;
   after receiving the movement data, determine updated landing instructions that cause the in-bound autonomous vehicle to avoid traffic while traveling to the landing pad; and
   provide the updated landing instructions to the in-bound autonomous vehicle.

Clause 29. The mobile terminal system of Clause 23, wherein:
the system further comprises one or more occupancy sensors that are deployed in, on, or adjacent to the landing pad to determine whether the landing pad is occupied; and
the hardware processor is further configured to:
   receive occupancy data from the one or more occupancy sensors indicating that the landing pad is occupied;
   after receiving the occupancy data, determine updated landing instructions that prevent the in-bound autonomous vehicle from entering the landing pad while the landing pad is occupied; and
   provide the updated landing instructions to the in-bound autonomous vehicle.

Clause 30. The mobile terminal system of Clause 22, wherein the hardware processor is further configured to:
determine that the in-bound autonomous vehicle has reached the landing pad; and
after determining the in-bound autonomous vehicle has reached the landing pad, provide an alert to initiate post-landing activities.

Clause 31. A mobile terminal system to operate a fleet of autonomous vehicles, the mobile terminal system comprising:
position delineators configured when deployed to establish a terminal site within a physical space, wherein the established terminal site comprises a launchpad sized and shaped to accommodate an autonomous vehicle of the fleet; and
a control subsystem comprising a hardware processor communicatively coupled to a memory and configured to:
   determine that an autonomous vehicle of the fleet is requesting to depart from the launchpad;
   after determining that the autonomous vehicle is requesting to depart from the launchpad, determine launch instructions indicating whether the autonomous vehicle can exit the launchpad and a route along which the autonomous vehicle is to travel after exiting the launchpad; and
   provide the launch instructions to the autonomous vehicle, wherein the launch instructions cause the autonomous vehicle to exit the launchpad and move along the route.

Clause 32. The mobile terminal system of Clause 31, wherein the control subsystem further comprises:
the control subsystem further comprises a set of sensors comprising a global positioning system (GPS) transceiver operable to determine route data indicating an external route for the autonomous vehicles of the fleet to travel along to reach the established terminal site; and
the hardware processor is further configured to provide the route data to at least one autonomous vehicle of the fleet.

Clause 33. The mobile terminal system of Clause 32, wherein:
the hardware processor is further configured to receive instructions indicating that a new terminal site needs to be established;
the global positioning system is operable to determine new route data indicating a new route for the autonomous vehicles of the fleet to travel along to reach the new terminal site; and
the hardware processor is further configured to provide the new route data to the at least one autonomous vehicle of the fleet.

Clause 34. The mobile terminal system of Clause 31, wherein the launch instructions comprise at least one of a time during which the autonomous vehicle can depart from the launchpad and a route within the established terminal site along which the autonomous vehicle travels to move away from the launchpad.

Clause 35. The mobile terminal system of Clause 31, wherein the hardware processor is further configured to, prior to providing the launch instructions, determine that an area around the launchpad is unoccupied.

Clause 36. The mobile terminal system of Clause 35, wherein the hardware processor is further configured to determine that the area around the launchpad is unoccupied by determining, using sensor data, that the area around the launchpad is free of objects, animals, or people preventing movement of the autonomous vehicle out of the launchpad.

Clause 37. The mobile terminal system of Clause 35, wherein:
the system further comprises one or more sensors that are deployed in, on, or adjacent to the launchpad to determine whether the area around the launchpad is unoccupied; and the hardware processor is further configured to:
receive sensor data from the one or more sensors indicating the area around the launchpad is occupied;
after receiving the sensor data, determine updated launch instructions that prevent the autonomous vehicle from departing from the launchpad while the area around the launchpad is occupied; and
provide the updated launch instructions to the autonomous vehicle.

Clause 38. The mobile terminal system of Clause 35, wherein:
the system further comprises one or more movement sensors that are deployed within the established terminal site; and the hardware processor is further configured to:
   receive sensor data from the one or more movement sensors indicating traffic within the established terminal site;
   after receiving the sensor data, determine updated launch instructions that cause the autonomous vehicle to move away from the launchpad and avoid traffic; and
   provide the updated launch instructions to the autonomous vehicle.

Clause 39. The mobile terminal system of Clause 35, wherein the updated launch instructions indicate an alternate route away for the autonomous vehicle to travel along after exiting the launchpad.

Clause 40. A mobile terminal system to operate a fleet of autonomous vehicles, the mobile terminal system comprising:
position delineators configured when deployed to establish a terminal site within a physical space, wherein the established terminal site comprises:
   at least one landing pad sized and shaped to accommodate an in-bound autonomous vehicle of the fleet; and
   at least one launchpad sized and shaped to accommodate an out-bound autonomous vehicle of the fleet; and
a control subsystem comprising a hardware processor configured to:
   determine that the in-bound autonomous vehicle is in-bound to the established terminal site;
   after determining that the in-bound autonomous vehicle is in-bound to the established terminal site, determine landing instructions indicating a landing pad in which the in-bound autonomous vehicle is to stop and a route that the in-bound autonomous vehicle is to travel along to reach the landing pad;
   provide the landing instructions to the in-bound autonomous vehicle, wherein the landing instructions cause the in-bound autonomous vehicle to move to the landing pad;
   determine that the out-bound autonomous vehicle is requesting to depart from the launchpad;
   after determining that the out-bound autonomous vehicle is requesting to depart from the launchpad, determine launch instructions indicating whether the out-bound autonomous vehicle can exit the launchpad and a route along which the out-bound autonomous vehicle is to travel after exiting the launchpad; and
   provide the launch instructions to the out-bound autonomous vehicle, wherein the launch instructions cause the out-bound autonomous vehicle to exit the launchpad and move along the route.

Clause 41. The mobile terminal system of Clause 40, wherein:
the equipment further comprises one or more movement sensors that are deployed within the established terminal site; and
the hardware processor is further configured to:
   receive sensor data from the one or more movement sensors indicating an amount of traffic within the established terminal site; and
   after receiving the sensor data:
      determine updated landing instructions that cause the in-bound autonomous vehicle to avoid traffic while traveling to the landing pad by following a first alternate route to the landing pad;
      provide the updated landing instructions to the in-bound autonomous vehicle;
      determine updated launch instructions that cause the out-bound autonomous vehicle to move away from the launchpad and avoid traffic by following a second alternate route away from the launchpad; and
      provide the updated launch instructions to the out-bound autonomous vehicle.

Clause 42. The system of any of Clauses 1-7, wherein the processor is further configured to perform one or more operations of a method according to any of Clauses 8-14.

Clause 43. An apparatus comprising means for performing a method according to any of Clauses 8-14.

Clause 44. A system according to any of Clauses 1-7, 15-21, 22-30, 31-39, or 40-41.

Clause 45. A method comprising:
establishing a terminal site within a physical space, wherein the established terminal site comprises at least one landing pad sized and shaped to accommodate an autonomous vehicle of a fleet;
determining that an autonomous vehicle of the fleet is in-bound to the established terminal site;
determining, after determining that the autonomous vehicle is in-bound to the established terminal site, landing instructions indicating a landing pad in which the in-bound autonomous vehicle is to stop and a route that the in-bound autonomous vehicle is to travel along to reach the landing pad; and
providing the landing instructions to the in-bound autonomous vehicle, wherein the landing instructions cause the in-bound autonomous vehicle to travel along the route to the landing pad.

Clause 46. The method of Clause 45, further comprising:
determining route data indicating an external route for the autonomous vehicles of the fleet to travel along to reach the established terminal site; and providing the route data to at least one autonomous vehicle of the fleet.

Clause 47. The method of Clause 46, further comprising:
receiving instructions indicating that a new terminal site needs to be established;
determining new route data indicating a new route for the autonomous vehicles of the fleet to travel along to reach the new terminal site; and
providing the new route data to the at least one autonomous vehicle of the fleet.

Clause 48. The method of Clause 45, further comprising:
determining that the in-bound autonomous vehicle is in-bound to the established terminal site by receiving a landing request from the in-bound autonomous vehicle, the landing request comprising a request for the in-bound autonomous vehicle to be granted permission to stop at the landing pad of the established terminal site.

Clause 49. The method of Clause 45, further comprising:
determining that the in-bound autonomous vehicle is on route to the established terminal site when one or both of the following are satisfied: (i) the in-bound autonomous vehicle is within threshold distance of the established terminal site and (ii) the in-bound autonomous vehicle is traveling along a known route to the established terminal site.

Clause 50. The method of Clause 45, wherein the landing instructions comprise at least one of a time during which the in-bound autonomous vehicle can enter the established terminal site, a route within the established terminal site that the in-bound autonomous vehicle is to travel along to reach the landing pad, a location of the landing pad within the established terminal site, and an identifier of the landing pad.

Clause 51. The method of Clause 45, further comprising:
receiving movement data from one or more movement sensors indicating an amount of traffic within the established terminal site;
determining, after receiving the movement data, updated landing instructions that cause the in-bound autonomous vehicle to avoid traffic while traveling to the landing pad; and
providing the updated landing instructions to the in-bound autonomous vehicle.

Clause 52. The method of Clause 45, further comprising:
receiving occupancy data from one or more occupancy sensors indicating that the landing pad is occupied;
determining, after receiving the occupancy data, updated landing instructions that prevent the in-bound autonomous vehicle from entering the landing pad while the landing pad is occupied; and
providing the updated landing instructions to the in-bound autonomous vehicle.

Clause 53. The method of Clause 45, further comprising:
determining that the in-bound autonomous vehicle has reached the landing pad; and providing, after determining the in-bound autonomous vehicle has reached the landing pad, an alert to initiate post-landing activities.

Clause 54. A non-transitory computer-readable medium storing instructions that when executed by a processor cause the processor to:
determine that an autonomous vehicle of a fleet is in-bound to an established terminal site within a physical space, wherein the established terminal site comprises at least one landing pad sized and shaped to accommodate an autonomous vehicle of a fleet;
determine, after determining that the autonomous vehicle is in-bound to the established terminal site, landing instructions indicating a landing pad in which the in-bound autonomous vehicle is to stop and a route that the in-bound autonomous vehicle is to travel along to reach the landing pad; and
provide the landing instructions to the in-bound autonomous vehicle, wherein the landing instructions cause the in-bound autonomous vehicle to travel along the route to the landing pad.

Clause 55. The non-transitory computer-readable medium of Clause 54, wherein the instructions further cause the processor to:
receive occupancy data from one or more occupancy sensors indicating that the landing pad is occupied;
determine, after receiving the occupancy data, updated landing instructions that prevent the in-bound autonomous vehicle from entering the landing pad while the landing pad is occupied; and
provide the updated landing instructions to the in-bound autonomous vehicle.

Clause 56. The system of any of Clauses 22-30, wherein the processor is further configured to perform one or more operations of a method according to any of Clauses 45-53.

Clause 57. The system of any of Clauses 22-30, wherein the processor is further configured to perform one or more operations according to any of Clauses 54-55.

Clause 58. An apparatus comprising means for performing a method according to any of Clauses 45-53.

Clause 59. An apparatus comprising means for performing a method according to any of Clauses 54-55.

Clause 60. The non-transitory computer-readable medium of any of Clauses 54-55 storing instructions that when executed by the processor cause the processor to perform one or more operations of a method according to any of Clauses 45-53.

Clause 61. The system of any of Clauses 1-7, 15-21, wherein the processor is further configured to perform one or more operations of a method according to any of Clauses 8-14.

Clause 62. The system of any of Clauses 1-7, wherein the processor is further configured to perform one or more operations according to any of Clauses 15-21.

Clause 63. An apparatus comprising means for performing a method according to any of Clauses 8-14.

Clause 64. An apparatus comprising means for performing a method according to any of Clauses 1-7, 15-21.

Clause 65. A method comprising one or more operations according to any of Clauses 1-7, 15-21.

Clause 66. The mobile terminal system according to any combination of Clauses 22-41.

What is claimed is:

1. A mobile terminal system to operate a fleet of autonomous vehicles, the mobile terminal system comprising:
position delineators configured when deployed to establish a terminal site within a physical space, wherein the established terminal site comprises at least one landing pad sized and shaped to accommodate an autonomous vehicle of the fleet; and
a control subsystem comprising a hardware processor configured to:
determine that an autonomous vehicle of the fleet is in-bound to the established terminal site;
after determining that the autonomous vehicle is in-bound to the established terminal site, determine landing instructions indicating a landing pad in which the in-bound autonomous vehicle is to stop and a route that the in-bound autonomous vehicle is to travel along to reach the landing pad; and
provide the landing instructions to the in-bound autonomous vehicle, wherein the landing instructions cause the in-bound autonomous vehicle to travel along the route to the landing pad.

2. The mobile terminal system of claim 1, wherein:
the control subsystem further comprises a set of sensors comprising a global positioning system transceiver operable to determine route data indicating an external route for the autonomous vehicles of the fleet to travel along to reach the established terminal site; and
the hardware processor is further configured to provide the route data to at least one autonomous vehicle of the fleet.

3. The mobile terminal system of claim 2, wherein:
the hardware processor is further configured to receive instructions indicating that a new terminal site needs to be established;
the global positioning system is operable to determine new route data indicating a new route for the autonomous vehicles of the fleet to travel along to reach the new terminal site; and
the hardware processor is further configured to provide the new route data to the at least one autonomous vehicle of the fleet.

4. The mobile terminal system of claim 1, wherein the hardware processor is further configured to determine that the in-bound autonomous vehicle is in-bound to the established terminal site by receiving a landing request from the in-bound autonomous vehicle, the landing request comprising a request for the in-bound autonomous vehicle to be granted permission to stop at the landing pad of the established terminal site.

5. The mobile terminal system of claim 1, wherein the hardware processor is further configured to determine that the in-bound autonomous vehicle is on route to the established terminal site when one or both of the following are satisfied: (i) the in-bound autonomous vehicle is within threshold distance of the established terminal site and (ii) the in-bound autonomous vehicle is traveling along a known route to the established terminal site.

6. The mobile terminal system of claim 1, wherein the landing instructions comprise at least one of a time during which the in-bound autonomous vehicle can enter the established terminal site, a route within the established terminal site that the in-bound autonomous vehicle is to travel along to reach the landing pad, a location of the landing pad within the established terminal site, and an identifier of the landing pad.

7. The mobile terminal system of claim 1, wherein:
the system further comprises one or more movement sensors that are deployed within the established terminal site; and
the hardware processor is further configured to:
receive movement data from the one or more movement sensors indicating an amount of traffic within the established terminal site;
after receiving the movement data, determine updated landing instructions that cause the in-bound autonomous vehicle to avoid traffic while traveling to the landing pad; and
provide the updated landing instructions to the in-bound autonomous vehicle.

8. The mobile terminal system of claim 1, wherein:
the system further comprises one or more occupancy sensors that are deployed in, on, or adjacent to the landing pad to determine whether the landing pad is occupied; and
the hardware processor is further configured to:
receive occupancy data from the one or more occupancy sensors indicating that the landing pad is occupied;
after receiving the occupancy data, determine updated landing instructions that prevent the in-bound autonomous vehicle from entering the landing pad while the landing pad is occupied; and
provide the updated landing instructions to the in-bound autonomous vehicle.

9. The mobile terminal system of claim 1, wherein the hardware processor is further configured to:
determine that the in-bound autonomous vehicle has reached the landing pad; and
after determining the in-bound autonomous vehicle has reached the landing pad, provide an alert to initiate post-landing activities.

10. A method comprising:
establishing a terminal site within a physical space, wherein the established terminal site comprises at least one landing pad sized and shaped to accommodate an autonomous vehicle of a fleet;
determining that an autonomous vehicle of the fleet is in-bound to the established terminal site;
determining, after determining that the autonomous vehicle is in-bound to the established terminal site, landing instructions indicating a landing pad in which the in-bound autonomous vehicle is to stop and a route that the in-bound autonomous vehicle is to travel along to reach the landing pad; and
providing the landing instructions to the in-bound autonomous vehicle, wherein the landing instructions cause the in-bound autonomous vehicle to travel along the route to the landing pad.

11. The method of claim 10, further comprising:
determining route data indicating an external route for the autonomous vehicles of the fleet to travel along to reach the established terminal site; and
providing the route data to at least one autonomous vehicle of the fleet.

12. The method of claim 11, further comprising:
receiving instructions indicating that a new terminal site needs to be established;
determining new route data indicating a new route for the autonomous vehicles of the fleet to travel along to reach the new terminal site; and
providing the new route data to the at least one autonomous vehicle of the fleet.

13. The method of claim 10, further comprising:
determining that the in-bound autonomous vehicle is in-bound to the established terminal site by receiving a landing request from the in-bound autonomous vehicle, the landing request comprising a request for the in-bound autonomous vehicle to be granted permission to stop at the landing pad of the established terminal site.

14. The method of claim 10, further comprising:
determining that the in-bound autonomous vehicle is on route to the established terminal site when one or both of the following are satisfied: (i) the in-bound autonomous vehicle is within threshold distance of the established terminal site and (ii) the in-bound autonomous vehicle is traveling along a known route to the established terminal site.

15. The method of claim 10, wherein the landing instructions comprise at least one of a time during which the in-bound autonomous vehicle can enter the established terminal site, a route within the established terminal site that the in-bound autonomous vehicle is to travel along to reach the landing pad, a location of the landing pad within the established terminal site, and an identifier of the landing pad.

16. The method of claim 10, further comprising:
receiving movement data from one or more movement sensors indicating an amount of traffic within the established terminal site;
determining, after receiving the movement data, updated landing instructions that cause the in-bound autonomous vehicle to avoid traffic while traveling to the landing pad; and
providing the updated landing instructions to the in-bound autonomous vehicle.

17. The method of claim 10, further comprising:
receiving occupancy data from one or more occupancy sensors indicating that the landing pad is occupied;
determining, after receiving the occupancy data, updated landing instructions that prevent the in-bound autonomous vehicle from entering the landing pad while the landing pad is occupied; and
providing the updated landing instructions to the in-bound autonomous vehicle.

18. The method of claim 10, further comprising:
determining that the in-bound autonomous vehicle has reached the landing pad; and
providing, after determining the in-bound autonomous vehicle has reached the landing pad, an alert to initiate post-landing activities.

19. A non-transitory computer-readable medium storing instructions that when executed by a processor cause the processor to:
determine that an autonomous vehicle of a fleet is in-bound to an established terminal site within a physical space, wherein the established terminal site comprises at least one landing pad sized and shaped to accommodate an autonomous vehicle of a fleet;
determine, after determining that the autonomous vehicle is in-bound to the established terminal site, landing instructions indicating a landing pad in which the in-bound autonomous vehicle is to stop and a route that the in-bound autonomous vehicle is to travel along to reach the landing pad; and
provide the landing instructions to the in-bound autonomous vehicle, wherein the landing instructions cause the in-bound autonomous vehicle to travel along the route to the landing pad.

20. The non-transitory computer-readable medium of claim 19, wherein the instructions further cause the processor to:
receive occupancy data from one or more occupancy sensors indicating that the landing pad is occupied;
determine, after receiving the occupancy data, updated landing instructions that prevent the in-bound autonomous vehicle from entering the landing pad while the landing pad is occupied; and
provide the updated landing instructions to the in-bound autonomous vehicle.
